(19) United States
(12) Patent Application Publication
(10) Pub. No.: US 2012/0046949 A1
(43) Pub. Date: Feb. 23, 2012

(54) METHOD AND APPARATUS FOR GENERATING AND DISTRIBUTING A HYBRID VOICE RECORDING DERIVED FROM VOCAL ATTRIBUTES OF A REFERENCE VOICE AND A SUBJECT VOICE

(76) Inventors: Patrick John Leddy, Diamond Bar, CA (US); Ronald R. Shea, Sherman Oaks, CA (US)

(21) Appl. No.: 13/212,148

(22) Filed: Aug. 17, 2011

Related U.S. Application Data
(63) Continuation-in-part of application No. 13/078,006, filed on Apr. 1, 2011.
(60) Provisional application No. 61/375,876, filed on Aug. 23, 2010.
(60) Provisional application No. 61/375,876, filed on Aug. 23, 2010.
(60) Provisional application No. 61/489,217, filed on May 23, 2011.

(51) Int. Cl. G10L 13/08

(52) U.S. Cl. 704/260; 704/E13.001

(57) ABSTRACT

A first person narrates a selected written text to generate a reference audio file including one or more parameters are selected from the sounds of the reference audio file, including the duration of a sound, the duration of a pause, the rise and fall of frequency relative to a reference frequency, and/or volume differential between select sounds. A voice profile library contains a phonetic library of sounds spoken by a subject speaker. An integration module generates a preliminary audio file of the selected text in the voice of the subject speaker and then modifies individual sounds by the parameters from the reference file, forming a hybrid audio file. The hybrid audio file retains the tonality of the subject voice, but incorporates the rhythm, cadence and inflections of the reference voice. The reference audio file, and/or the hybrid audio file are licensed or sold as part of a commercial transaction.

### RELATED APPLICATIONS

This application is a Continuation-In-Part of U.S. patent application Ser. No. 13/078,006, filed Apr. 1, 2011, and claims benefit of priority therefrom. U.S. patent application Ser. No. 13/078,006 is incorporated by reference in its entirety herein. U.S. patent application Ser. No. 13/078,006 claims benefit of priority, and incorporates by references, U.S. Provisional Pat. App. No. 61/375,876 to Leddy, filed 23 Aug. 2010. This application also claims benefit of priority, and incorporates by reference, U.S. Provisional Patent Application No. 61/489,217 filed May 23, 2011.

### BACKGROUND OF THE INVENTION

Among the consuming public, celebrities hold a special attraction. Because of this, Hollywood movies often used famous voices for cartoon characters. Even if a consumer cannot instantly “name” the voice behind a cartoon character, there is a familiarity with a publicly recognizable voice that forms a bond with the consuming public. Publicly recognizable voices are commonly found among major motion picture stars, TV and radio talk show hosts, TV news reporters and anchors, TV stars, and major political figures. A few historical figures, such as Ronald Regan, Franklin D. Roosevelt, Winston Churchill and Adolph Hitler have had major speeches replayed often enough to achieve highly recognizable voices as well.

In addition to publicly recognizable voices, there exists a small set of men and women whose voices, though not quite so recognizable, are, or were, highly trained, and possessing profound commercial value. Often they are not famous because they practiced their craft in a specialized field such as Shakespearian actors who were never widely known by the public. And oftentimes, they are deceased. Such voices would include the late Sir Laurence Olivier, the late Sir John Gielgud, and the late Alexander Scourby. Because they are deceased, and no longer in the public image, their voices may no longer qualify as “famous” or highly recognizable. Yet the tonality, elocution, diction, lyrical cadence, and overall quality of their highly trained voices represents a vast untapped potential for the profound commercial value of their voices.

Finally, people are familiar with the voices of their family members, including their own voice. There is something profoundly comforting and reassuring in the voice of one's parent, who may have read a bedtime story aloud to their child every night. Some occupations, such as submariners in the navy, or soldiers in the army and marines, regularly take parents away from their children for extended periods of time, depriving their children of the warmth and comfort afforded by their parent's voice. And, when a parent is deceased, their children are forever more deprived of the warmth and comfort of their parent's voice.

### SUMMARY OF THE INVENTION

There exists therefore a need for a method and apparatus for exploiting the commercial value of famous voices and highly trained voices. There further exists the need to make the voices of absent parents available to their children and loved ones. There further exists the need to make the voices of deceased persons available for surviving loved ones. The following disclosure is crafted to enable one of ordinary skill in the art to make and use the embodiments necessary to address these needs and achieve these objectives.

### BRIEF DESCRIPTION OF THE SEVERAL VIEWS OF THE DRAWINGS

FIG. 1 depicts an overview of a network and apparatus architecture for use in generating customs and edit digital voice recordings.

FIG. 2 depicts an overview of a method for analyzing speech patterns correspond to a written text, and generating data for storage in a voice profile library.

FIG. 3A depicts an embodiment of a universal phonetic alphabet.

FIG. 3B depicts an embodiment of a universal phonetic library comprising alternative frequencies and durations of the universal phonetic alphabet.

FIG. 4 depicts a method for establishing frequency gradations and gradations in sound duration for the universal phonetic library.

FIG. 5 depicts a method for generating a text-to-voice library or personal voice profile from a universal phonetic library.

FIG. 6A depicts a sample syntax (computer code) for depicting individual words using the universal phonetic library embodiment.

FIG. 6B depicts an embodiment of FIG. 6A using a flexible syntax configured to cover a range of duration rather than a single duration.

FIG. 7 depicts an embodiment of an acoustic envelope.

FIG. 8 depicts discrete segments which can be combined to form an acoustic envelope.

FIG. 9 depicts an embodiment of an acoustic envelope library.

FIG. 10 depicts a method for developing an acoustic envelope library.

FIG. 11 depicts a method for generating a text-to-voice library according to an acoustic envelope embodiment.

FIG. 12A depicts a sample syntax (computer code) for depicting individual words using the acoustic envelope embodiment.

FIG. 12B depicts an embodiment of FIG. 12A using a flexible syntax configured to cover a range of duration rather than a single duration.

FIG. 13A depicts an example of text to voice code utilizing morphological, syntactical and grammatical correlates in conjunction with acoustic envelope library embodiment.

FIG. 13B depicts an example of text to voice code utilizing morphological, syntactical and grammatical correlates in conjunction with universal phonetic library embodiment.

FIG. 14 depicts a method for generating a voice profile library configured to incorporate morphological, syntactical and grammatical correlates.

FIG. 15 depicts a method of formulating (or updating) a Personal Voice Profile

FIG. 16 depicts a method of generating a custom synthetic digital voice recording of a selected text according to a predetermined voice.

FIG. 17 depicts an overview of a method for generating a voice recording of a printed text by combining tonality (major frequency and overtones) and other personal features of a subject voice with the cadence, intonation and volume modulation of a reference voice reciting a printed text.

FIG. 18 depicts an apparatus and network receiving input from a subject speaker and a reference speaker to extract necessary vocal features necessary to generate the voice recording by the methods described in FIGS. 17 and 19.

FIG. 19 depicts a data table correlating discrete “sounds” from a printed text to respective sounds of a reference voice, a synthesized subject voice, and a hybrid synthetic digital voice recording that derives aspects from both the reference voice and the subject voice.

### DETAILED DESCRIPTION

Overview of System Architecture and Operation

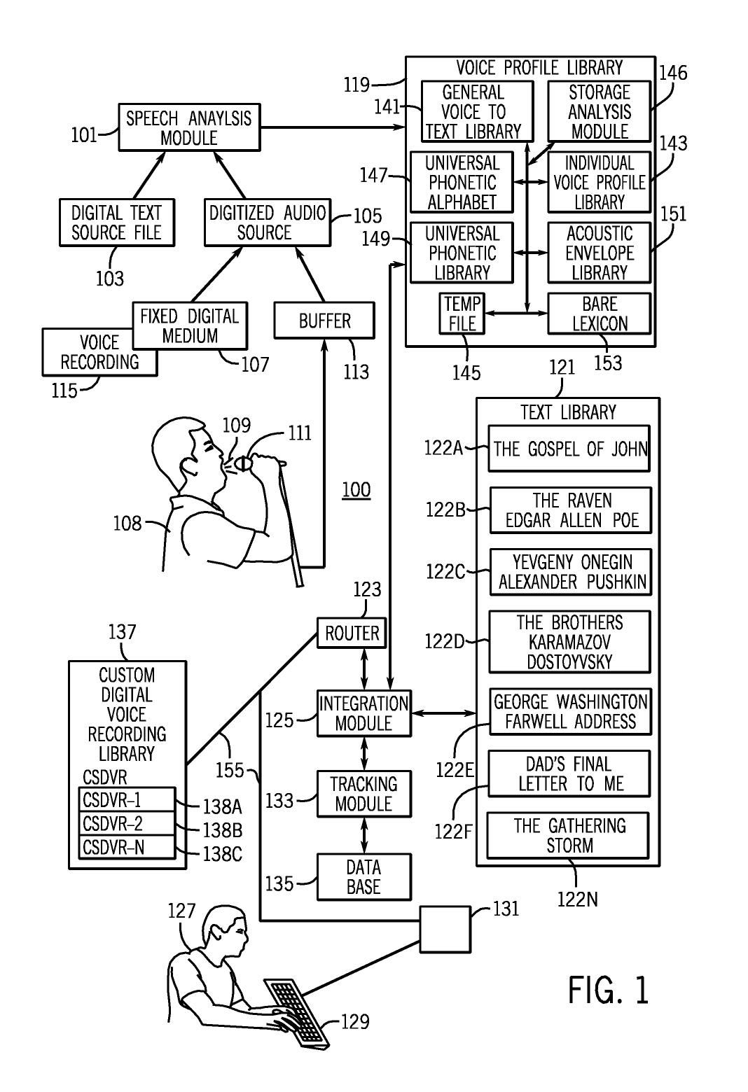

FIG. 1 depicts an embodiment of a network 100 and apparatus for converting written text into a digital audio file in the voice a predetermined speaker, also referred to herein as custom synthetic digital voice recordings (CSDVRs). Specific aspects of this general architecture will be disclosed in greater detail in subsequent figures. The audio input device 111 shown in FIG. 1 as a microphone, receives audio input 109, shown in FIG. 1 as a human voice, from a particular human speaker 108. In the embodiment depicted in FIG. 1, the audio input device 111 includes an analog to digital converter so that the signal sent to the buffer 113 is already digitized. The reader will appreciate, however, that distributed architectures are also envisioned, wherein the signal transmitted from the microphone is analog, and is subsequently converted to a digital signal through an apparatus separate from the audio input device 111. An optional buffer 113 includes an input coupled to an audio input device (e.g., a microphone) 111, and an output coupled to an input of the digital audio interface 105.

The network 100 also the depicts an embodiment with a voice recording 115 stored on a fixed digital medium 107 such as a compact disc or a flash memory storage device. The voice recording is accessed by the digital audio interface 105.

In an embodiment, the digital audio interface 105 may simply be an optical port or in electrical port comprising one or more conductive members configured to receive an electrical signal at an input of the speech analysis module 101.

In an embodiment, the digital audio interface 105 may include signal processing capabilities, thereby establishing a distribution of tasks between the digital audio interface 105 and the speech analysis module 101.

The signal processing capabilities of the digital audio interface 105 may include multi-functional capacity—the ability to receive two or more alternative signal protocols, compact disk, microphone input, MP3 files, and to process them into a protocol appropriate for analysis by the speech analysis module 101. Accordingly, different embodiments involving distributed architecture or consolidated architecture are envisioned in the following description, and all of the descriptions herein should be considered in this light.

The speech analysis module 101 has a first input coupled to receive a digitized text source file 103, and a second input coupled to receive the output signal of the digital audio interface 105. The speech analysis module is in signal continuity with the voice profile library 119. The speech analysis module compares sounds and words from the digital audio interface 105 to equivalent digitized text files 103 and generates output data for storage in the voice profile library 119, including the general text-to-voice library 141 and/or the individual text-to-voice library 143 containing a plurality of personal voice profiles. Embodiments are therefore envisioned wherein the speech analysis module receives feedback from the voice profile library, and incorporates this feedback in its data processing functions. Alternative embodiments are also envisioned, wherein feedback from the voice profile library to the speech analysis module is limited to overhead functions such as a handshake, and signal confirmation, or no feedback at all.

The voice profile library 119 includes an input for receiving text-to-voice correlation data from the speech analysis module 101, either a Universal Phonetic Library 149, comprising a comprehensive catalogue of the sounds of human speech, or an Acoustic Envelope Library 151 from which all human vocal sounds can be reconstructed. From these sound libraries, the general text-to-voice library 141, and/or one or more individual text-to-voice libraries, referred to herein as personal voice profiles 143 can be generated.

In an embodiment, a digitized text file 103 and a digitized audio source 105 are received by the speech analysis module 101. The speech analysis module and/or the integration module 125 compare the incoming audio sounds to the available audio sounds in the Universal Phonetic Library 149 or the Acoustic Envelope Library 151, and define each word in terms of it component sounds or component envelopes, thereby generating an audio file for each word. Individual incoming words from the digitized text source file 103 are stored in a general voice-to-text library 141, a personal voice profile 143, or both, along with the corresponding audio file defined according to the components parts derived from the Universal Phonetic Library 149 or the Acoustic Envelope Library 151.

The voice profile library also has a storage-analysis module 146. The storage-analysis module compares data received from the speech analysis module 101 to the data stored in the text-to-voice libraries 141, 143, and it determines whether editions or alteration should be made to text-to-voice libraries 141, 143, or whether the incoming data is already represented therein. Incoming data may also change the “weight” associated with the pronunciation of a certain word which has alternative pronunciations. The voice profile library 119 advantageously includes temporary files 145 which can be used to store input data from the speech analysis module 101, as well as input data from the integration module 125.

The text library 121 includes one or more text files 122. For illustrative purposes, text library of FIG. 1 includes the Gospel of John 122a, the Raven 122b by Edgar Allan Poe, Yevgeny Onyegin 122c by Alexander Pushkin, The Brothers Karamazov 122d by Feodor Dostoyevsky, George Washington's Farewell Address 122e, The Gathering Storm 122f by Winston Churchill, and “Dad's final letter to me” 122g. As discussed in greater detail herein, digitized text within the text library may include basic text files, and may also include files incorporating Morphological, Syntactical & Grammatical (SMG) markers augmented text to allow statistical analysis of structures that may affect pronunciation, including duration, pitch (with overtones), volume, pauses, etc. According to an embodiment, digitized text within the text library may include a phonetic representation of text. However, it can be readily appreciated that different people may pronounce the same word differently. Accordingly, in a preferred embodiment, idiosyncratic questions of pronunciation are governed, at least in part, by data stored within the personal voice library of respective speakers.

Through the user interface, the user is also able to select a particular digital text file 122 in the voice of a person whose voice is represented within the voice profile library 119. In an embodiment, menu driven software allows the user 127 to select a particular digital text file 122 from the digital text library 121, and a particular voice 144a, 144b from among a plurality of voices available from the voice profile library 119. Search engines applications are advantageously used when the selection of voices in the voice profile library 119 and/or the number of digital text files 122 in the digital text library 121 grow to a point that menu driven software is cumbersome.

A user 127 requests a custom synthetic digital voice recording CSDVR of a written text 122-n represented within the text library 121 according to a predetermined voice 122-n represented within the voice profile library 119. The request can be entered through a remote interface, such as a mobile computing device such as a cellular telephone, a personal computer, or other digital devices. The embodiment depicted in FIG. 1 offers an example of user entry through a keyboard input 129 of a personal computer 131. Non-remote embodiments are also envisioned such as a public kiosk distribution system has taught in U.S. Pat. No. 7,779,058 “Method and Apparatus for Managing a Digital Inventory of Multimedia Files Stored across a Dynamic the Distributed Network” to Shea.

In response to the request, and an integration module 125 receives digital information from both the voice profile library 119 and the text library 121. The integration module integrates data from the voice profile library 119 with a text file 122 selected from the text library 121, and generates a custom synthetic digital voice recording CSDVR of the selected text in the voice 109 of a person 108 whose voice profile 120 was selected from the voice profile library.

In an embodiment, a router 123 connects the integration module 125 with custom digital voice recordings library 137 used for storing one or more custom synthetic digital voice recordings CSDVR_1, CSDVR_2 , , , CSDVR_n. If a user requests a voice recording that is already in the voice recording library 137, the recording is downloaded to the user without the need to generate the recording.

Non-distributed embodiments are also envisioned wherein some or all of the apparatuses and digital modules or applications depicted in FIG. 1 are disposed within a consumer device such as a personal computer.

Overview of System Operation

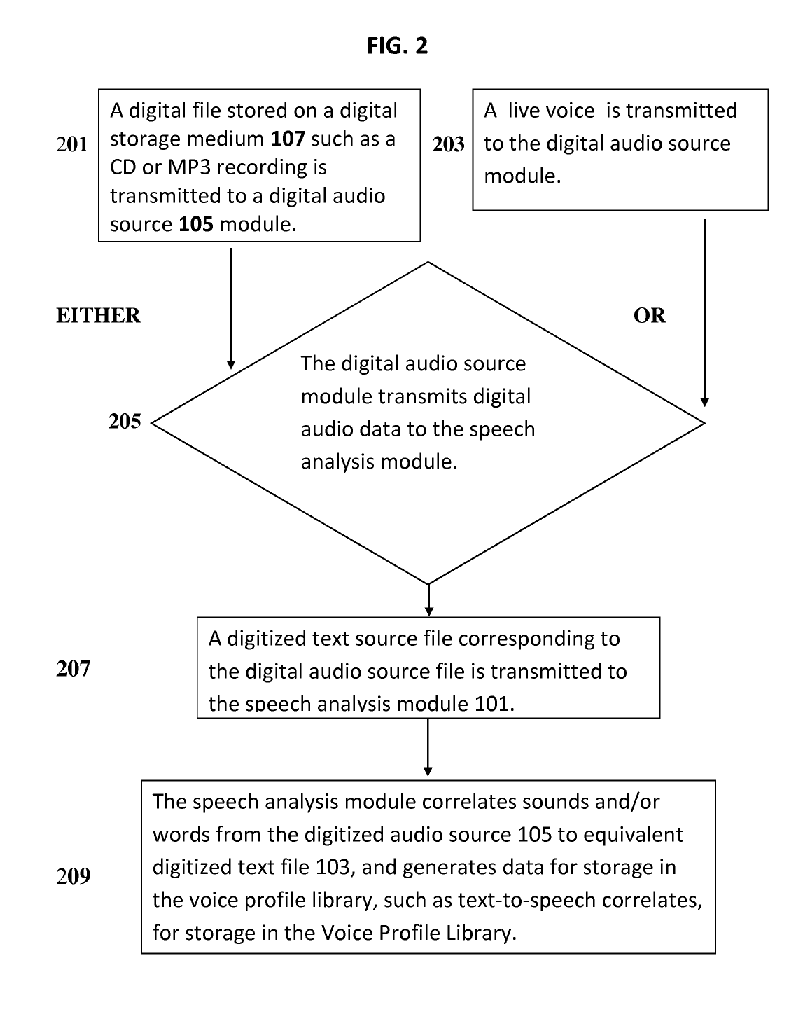

FIG. 2 depicts a method incorporating the foregoing elements of FIG. 1. In step 201, a digital file stored on a digital storage medium 107 such as a CD or MP3 recording is accessed by a digital audio interface 105. In an alternative step 203, a live voice 109 is transmitted to the digital audio interface 105. In step 205, the digital audio interface 105 transmits digital audio data to the speech analysis module 101. In step 207, a digitized text source file corresponding to the digital audio source file is transmitted to the speech analysis module 101. In step 209, the speech analysis module correlates sound and/or words from the digital audio interface 105 to equivalent words and sounds in the digitized text file 103. The speech analysis module generates data for storage in the voice profile library 119. Data generated by the speech analysis module includes, but is not limited to, text-to-speech correlates, various embodiments of which are discussed in greater detail herein.

To illustrate the foregoing embodiment, consider the example wherein all of the known vocal recordings of Winston Churchill are reduced to digitized text format, and stored in the digitized text file 103. The same vocal recordings of Winston Churchill are either streamed through the buffer 113 and into the digitized audio source file, or stored on a fixed digital medium 115. The speech analysis module 101 compares the text of Churchill speeches to his voice, and it generates text to voice correlates of Winston Churchill for storage in the voice profile library. In a subsequent step, a user selects a particular text (presumably, but not necessarily, a speech or work of Winston Churchill) and requests a custom synthetic digital voice recording of this work or speech in the voice of Winston Churchill. The integration module integrates digital data from the voice profile library 119 with the text library 121 to generate custom synthetic digital voice recording.

Tracking Module

Returning to FIG. 1, a tracking module 133 is advantageously coupled to the integration module for use in commercial applications. The tracking module may record, inter alia, the number of times a particular request is received by the network. If a particular custom synthetic digital voice recording is requested multiple times, a counter (or a more complex algorithm) may determine that it would be economically advantageous to permanently store the custom synthetic digital voice recording rather than to generate the same recording multiple times in response to multiple requests. It will be readily appreciated that some recordings may differ in quality depending on the recording algorithm used, and the digital file space which a user is willing to dedicate to store a sound recording. Embodiments are envisioned wherein higher-quality sound recordings are sold at a premium price. Embodiments are also envisioned wherein custom synthetic digital voice recordings identified for retention by the tracking module are generated at the highest level of quality. Lower quality recordings can be digitally “ripped” from a permanently stored high quality recording. This practice is commonly utilized, for example, in MP3 recordings.

Linear and Character Alphabets

Various embodiments described herein relate to “text-to-voice” and “voice-to-text” technology. As used herein, the concept of text is used in the broadest sense of the term. For example, linear alphabets are used for Western, Cyrillic, Greek, Arabic, Persian, Hebrew, East Indian and Korean writing. Linear alphabets typically have a comparatively smaller number of letters (e.g. 26 letters in the English alphabet), and words are formed from a combination of letters. Some languages using linear alphabets employ spaces between words, and others are written in a continuous stream of letters without spaces.

Some Asian countries such as China and Japan use character alphabets. In character alphabets, each character typically represents a separate word. Character alphabets may have upwards of 5,000 characters. In certain word processing application and programs, Asian characters may be “built up” by a series of elemental key strokes, each stroke forming a portion of a character. After a character has been fully formed, a keystroke such as the “enter” key on a standard keyboard can be used to indicate that the character is completed, inserting the completed character into the text.

Some “intermediate alphabets” such as Babylonian cuneiform may have about five-hundred characters, placing them somewhere “between” a twenty-six letter linear alphabet and a five-thousand character alphabet. Some alphabets may have characteristics of both linear and character alphabets. For example, before UNICODE, some “letters” of Myanmar could be built up from a sequence of key strokes, thereby resembling Asian characters in their complexity and formation. However, there are relatively few distinct characters (letters) in the Myanmar alphabet. In this sense, it more closely resembles a linear alphabet.

Some linear alphabets include optional accent or vowel marks. For example, the first paragraph of a Hebrew newspaper will often include “vowel points” (dots and strokes usually placed below consonants), whereas subsequent paragraphs will be written without vowel points. Russian can also be written with, or without accent marks. English is typically written without accent marks, with a few exceptions. English words borrowed from other languages will often retain the accent marks, such as the word café, taken from the French, and the King James Bible of 1611, the towering achievement of the English language, makes copious use of accent marks on proper nouns (generally names and places) of Hebrew origin, owing to the fact that their pronunciation is generally foreign to the English language.

Some languages include abbreviations, often identified as such by some structural marker. English typically places a period after an abbreviation. Fourth century Greek placed a horizontal line above a group of letters to indicate it was an abbreviation.

Some written languages include “contractions” wherein multiple words are combined into a single word. Often, one or more letters are omitted when the multiple words are combined in a contraction. A structural marker (such as an apostrophe in English or French) may be used to indicate that a word is a contraction. However, the apostrophe is not limited to this meaning in French and English, and may be used to indicate other grammatical nuances as well, such as possession. Similarly, a “dot” in the center of a certain Hebrew letter may indicate any one of a variety of distinct grammatical concepts depending on the context. A dot may indicate the letter is “doubled.” However, the same “dot” in the center of the same letter may take on an entirely different meaning in a different word, or different context.

English allows the addition of “prefixes” and “suffixes” at the beginning or end of certain words, and Arabic includes “infixes” in the middle of some words. Secretaries at one time took notes using “shorthand” to represent sounds rather than letters.

Phonetic Alphabets

As of 2008, the International Phonetic Alphabet (IPA) had one-hundred seven distinct letters representing distinct consonants and vowels of spoken language, fifty two diacritical marks, thirty-one of which further identify the nature of the sounds, and nineteen of which indicate length, tone, stress and intonation), and four prosody marks indicating aspects of rhythm, stress and intonation—such as to reflect whether an utterance is a statement, question, command, sarcasm, irony, contrast between words or concepts, emphasis of a word, etc.

Extensions of the IPA are used to indicate some sounds such as tooth gnashing, lisping, and sounds made by a speaker with a cleft palate. Even in the extended form, it is probable that many sounds of the human voice and mouth are not fully represented by the IPA. Some African languages incorporate whistling to allow one's voice to carry greater distances, and Zulu incorporates “clicking” sounds (creating a suction between the tongue and roof of the mouth, and withdrawing the tongue) which cannot even be represented by Western or Asian alphabets. “Popping” one's lips while exhaling can include a variety of forms, distinguished by force, duration, etc. The “raspberry” or “putzing” can be performed by tensing the muscle in one's lips and/or tongue while blowing air out through them, essentially producing a prolonged “vibrato” sound with one's lips or tongue. Inhaling, accented only by the lips produces various kissing sounds. Inhaling accented by dental placement can produce a variety of “tisk” sounds can be formed. Whatever the position of the lips, teeth and tongue, most sounds produced through exhaling are distinguishable from sounds produced through inhaling. These and other human vocal sounds all come in multiple forms, which may be distinguished by a variety of factors including duration, roundness of the mouth, protrusion of the lips, whether the tip of the tongue touches the pallet or teeth, or is near either, the position of the sides of the tongue, etc. The IPA is occasionally updated, possibly to reflect nuances of human language that are better appreciated as linguists and anthropologists categorize the full range of human sound.

The Universal Phonetic Alphabet

Throughout this disclosure, the term “Universal Phonetic Alphabet” (UPA) preferably incorporates the fully extended IPA, as well as any sounds of human speech which have not yet been categorized in the extended IPA (some of which have been discussed above). The Universal Phonetic Alphabet (UPA) described herein is preferably “open ended” in that it is updated as necessary to include any refinements (distinctions between sounds), recognition that certain sounds are, indeed, a legitimate aspect of human speech, or additions of newly discovered human sounds. However, the appended claims fully envision less comprehensive embodiments of a universally phonetic alphabet.

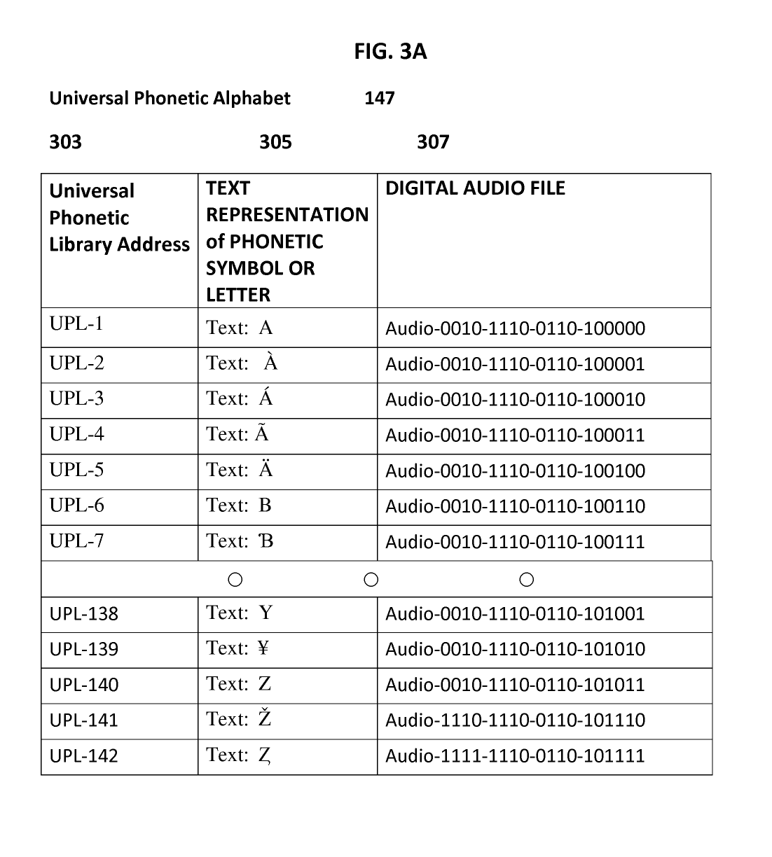

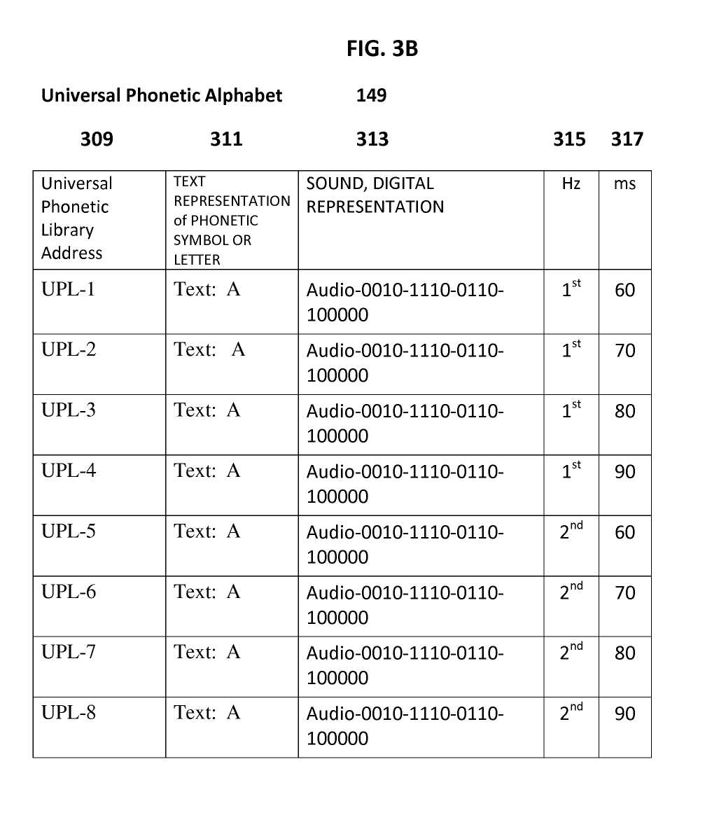

FIG. 3A depicts an embodiment of a Universal Phonetic Alphabet 147 with text (“letters” representing various UPA sounds) corresponding audio files. Column 303 represents addresses within a digital library. Column 305 discloses text symbols which might be used to represent different sounds in the Universal Phonetic Alphabet. The reader will appreciate that, when stored on a digital medium, the text characters will be represented by a binary string, whereas, when each individual text element are printed or displayed on a monitor, they will normally be represented as a glyph or character. FIG. 3A uses the “glyph” representation of text in column 305. A plurality of audio files 307 correspond to respective glyphs and addresses of the Universal Phonetic Alphabet. The binary code of the audio files in column 307 may represent any binary format, such as a sequence of an MP3 file.

FIG. 3B depicts a Universal Phonetic Library 149 (See FIG. 1) derived from the Universal Phonetic Alphabet 147. The distinction, in essence, between the alphabet 147 and the library 149 is that the library 149 accounts for all anticipated variations in frequency and duration of the sounds of the alphabet 147. Column 309 contains universal phonetic library addresses. Column 311 contains the text representation, similar to column 305 of FIG. 3. Column 313 contains digital audio files corresponding to the address and text in their respective rows and further corresponding to the frequency (column 315) and duration (column 317) of their respective rows.

Some sounds (letters), such as the “S,” “T,” and “P,” may have only one, or a very limited number of frequencies. These are often called “non-vocalized” sounds. In contrast, the letters “Z,” “D” and “B” are virtually the same sound as S, T and P, except that they are “vocalized,” the size and shape of the larynx of the speaker having a major effect on the frequency and overtones of these sounds. As a consequence, vocalized sounds are much more likely to encompass a wide range of frequencies. Similarly, vocalized sounds are likely to have wider variation in duration than non-vocalized sounds.

Due to spatial limitations, the Universal Phonetic Library 149 of FIG. 3B is limited to its depiction of the character “A” in various combinations of frequency and duration. The character “A” is not intended to represent any specific sound, but is used only as an example of a character in the Universal Phonetic Alphabet 147. In this example, system programmers and developers have determined that this sounded can be represented by only two frequencies (Hz) distinguishable to the human ear, represented by 1^{st} and 2^{nd} respectively. Similarly, system developers have determined that this sound virtually always comprises a duration between 60 ms and 90 ms, and have further determined from psychological acoustic studies at the human ear does not substantially distinguish between sample of this sound when varying by less than 10 ms. Accordingly, this particular sound from the Universal Phonetic Alphabet is represented in two frequencies, each frequency represented by four alternative durations. The reader will appreciate that, to represent the full range of human speech, one particular sound may be only require one or two frequencies, and another sounds may require over one hundred different frequencies. This depends both on the range of frequencies of the spoken voice, and the sensitivity of the human ear in distinguishing subtle changes in frequency.

The reader will also appreciate at the range of durations in milliseconds depicted in the Universal Phonetic Library 149 of FIG. 3B only ranges from 60 to 90 ms, and is in 10 ms increments. These details are offered only by way of example. The range of durations envisioned in an actual text of this sound table is as broad as the actual range of sounds observed in human speech.

The gradations of duration of sounds are advantageously incremented by amounts too small to be detected by the human ear, thereby ensuring that minute distinctions between the voices of two different speakers can be fully represented within the universal phonetic library 149. Similarly, the gradations in frequency are advantageously incremented by amounts too small to be detected by the human ear, thereby ensuring that every human voice can be uniquely reconstructed by the data stored within the voice to text library.

Development of a Universal Phonetic Library

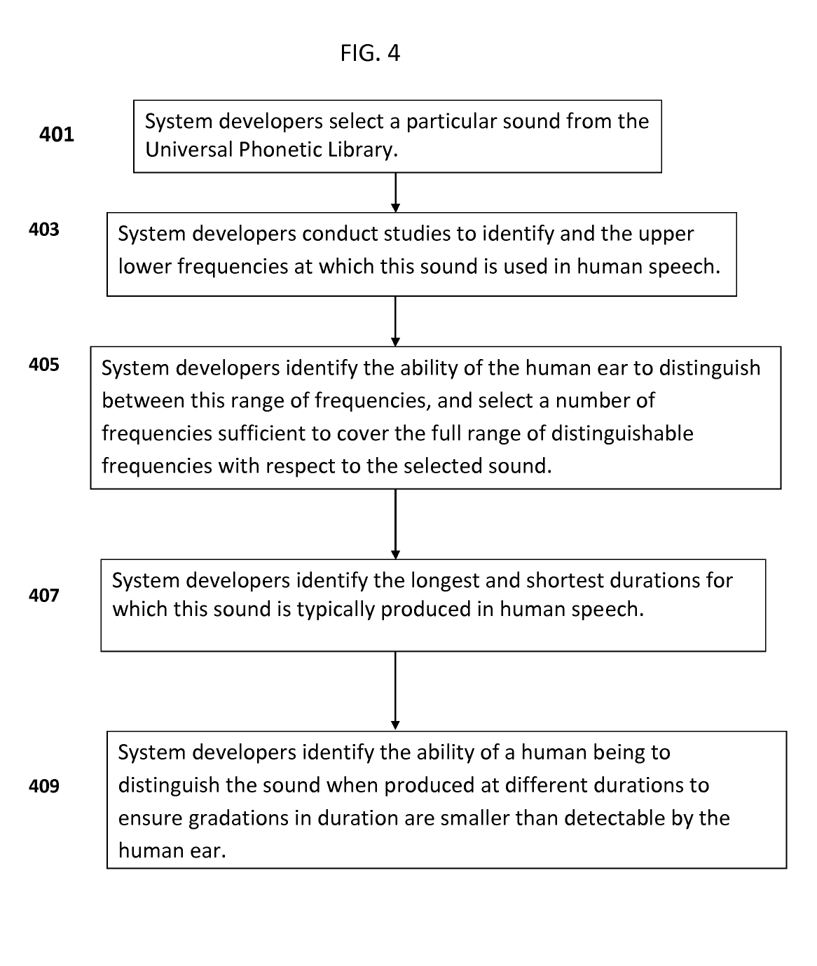

FIG. 4 depicts a method for developing a Universal Phonetic Library 149 of FIG. 3B from the Universal phonetic alphabet 147 of FIG. 3A. In step 401, system developers identify a particular sound from the Universal Phonetic Library. In step 403, system developers conduct studies to identify and the upper lower frequencies at which this sound is used in speech. In step 405, system developers identify the ability of the human ear to distinguish between this range of frequencies, and select a number of frequencies sufficient to cover the full range of distinguishable frequencies which will be represented within FIG. 3B for a particular sound. In step 407, system developers identify the longest and shortest durations for which this sound is typically produced in human speech. In step 409, system developers identify the ability of a human being to distinguish the sound when produced at different durations. This determines the number of distinct durations represented within FIG. 3B for a given sound at a given frequency.

Generating a General Text-to Voice Library or Personal Voice Profile from a Universal Phonetic Library.

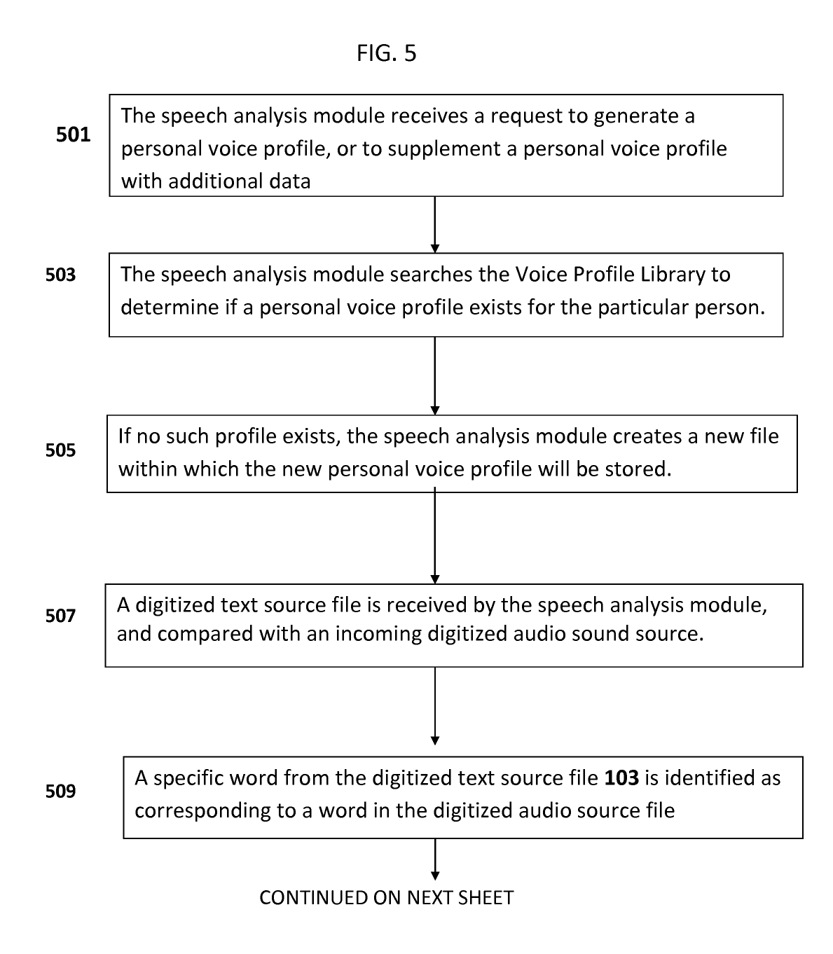

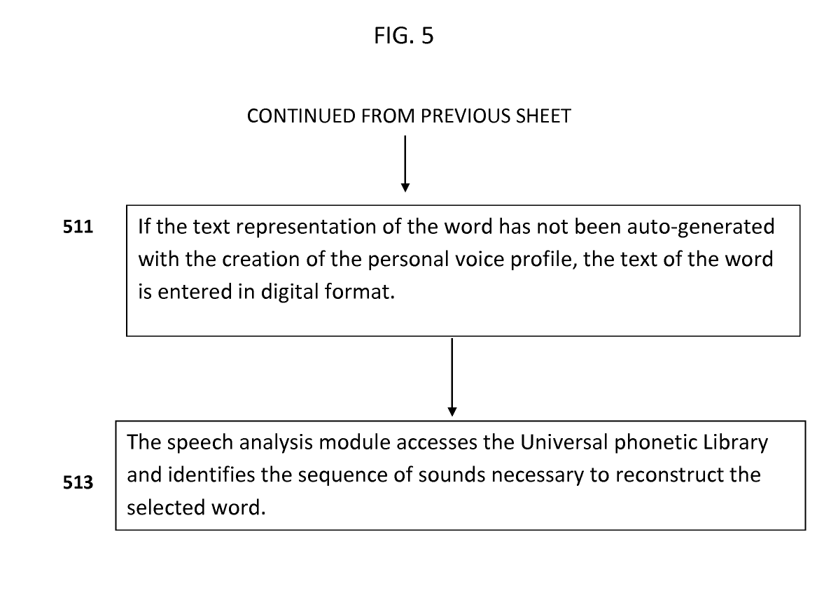

FIG. 5 describes a process for generating a general text-to-voice Library 141, and/or a personal voice profile 143, by combining discrete sounds from the Universal phonetic Library 149 to form specific sounds, preferably, though not necessarily, actual words which are listed in the general text-to-voice Library 141 or a personal voice profile 143.

After developing a general text-to-voice library 141 or a personal voice profile 143, in a subsequent operation, the integration module 125 accesses these text-to-voice libraries 141, 143 to generate custom synthetic digital voice recordings CSDVRs. However, it will be readily appreciated that the general text-to-voice library 141 or a personal voice profile 143 may not have every word represented within a specific text file 122 of the text library 121. Accordingly, alternative embodiments are envisioned wherein at least some of the words within a custom synthetic digital voice recording CSDVR are generated directly from the Universal phonetic Library 149 “on the fly.” In a preferred embodiment, any new words which are generated “on the fly” during the generation of a CSDVR are also stored in the appropriate word libraries 143, 143 thereby reducing the overhead necessary to generate each word for future CSDVRs. Some of the specific examples below are described in terms of generating a personal voice profile 143. The reader will readily appreciate that the same process can be used in the formation of a general text-to-voice library 141 with very few changes.

In step 501, the speech analysis module 101 receives a request to generate a personal voice profile 143, or to supplement a personal voice profile with additional data.

In step 503, the speech analysis module 101 (or some other apparatus, module or application) searches the Voice Profile Library 119 to determine if a personal voice profile 143 exists for the particular person.

In step 505, if no such profile exists, the speech analysis module creates a new file within which the new personal voice profile 143 will be stored. Embodiments are envisioned in which a newly generated personal voice profile (that is, an “empty” personal voice profile) includes a basic lexicon of words represented in text, as well as a “standard” phonetic spelling. The speech analysis module 101 is thereby able to store word sounds in predetermined digital fields which correspond to the textual representation of that word.

In step 507, a digitized text source file 103 is received by the speech analysis module 101, and compared with an incoming digitized audio sound source 105.

In step 509, a specific word from the digitized text source file 103 is identified as corresponding to a word in the digitized audio source file 105. To facilitate this correlation of written and spoken terms, the incoming digitized text source file 103 undergoing analysis will preferably include the phonetic spelling of every word according to the Universal Phonetic Alphabet 147, thereby enabling the speech analysis module to more accurately correlate spoken words to their respective text equivalents. A reference lexicon which includes phonetic spellings is advantageously stored within the voice profile Library 119. In an embodiment, the reference lexicon is auto generated within each personal voice profile 143 at its inception, as described in conjunction with step 505. The phonetic and standard spellings within this lexicon allows the speech analysis module 101 to 1) find a word within the lexicon which matches the incoming text word, 2) identify within the lexicon of one or more alternative pronunciations by their phonetic spelling, and 3) more easily correlating an incoming spoken word to word which is spelled phonetically.

In step 511, if the specific word from the digitized text source file 103 is not yet been recorded in the personal voice profile 143 corresponding to the new voice, the word is digitally entered. Preferably the personal voice profile 143 is organized and easily searchable manner, such as alphabetical order. As noted, alternative embodiments are envisioned wherein a personal voice profile 143 is generated to include a lexicon at its inception, thereby providing fillable digital fields for the addition of subsequent audio files.

In step 513, the speech analysis module 101 accesses the Universal phonetic Library 149 of FIG. 3B and identifies the sequence of sounds necessary to reconstruct the selected word. After the incorporation of a sufficient number of audio files of words within a personal voice profile, the personal voice profile will have sufficient data to allow the integration module 125 to generate a custom synthetic digital voice recording of a selected text 122 in that person's voice.

Architecture of a Personal Voice Profile According to the Universal Phonetic Library Embodiment

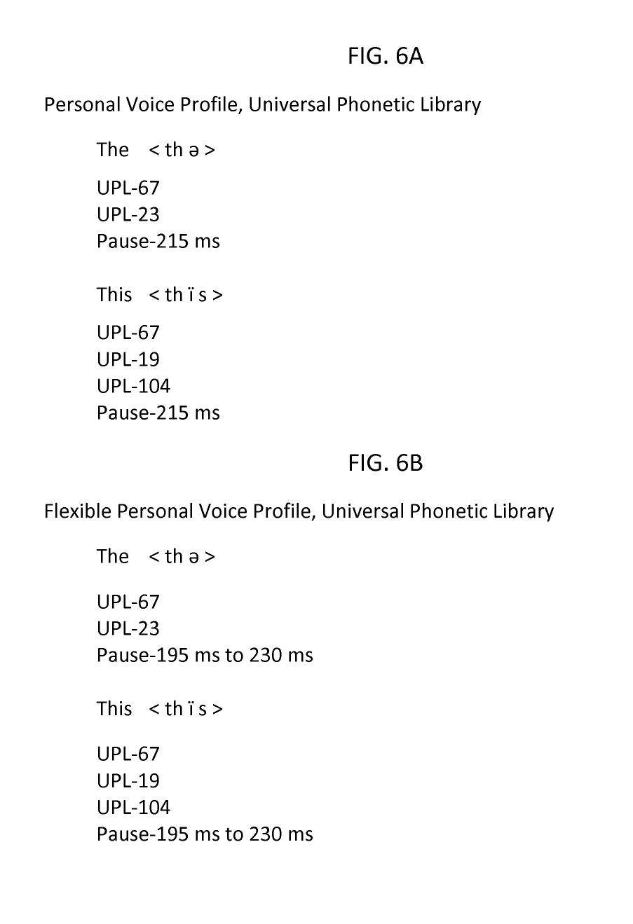

FIG. 6A depicts an example of digital code defining the spoken words in the voice of a particular speaker (for example, Winston Churchill) within an individual voice profile Library according to the Universal Phonetic Library embodiment of FIG. 3-A.

The reader will appreciate that the example of FIG. 6A is limited to only two words, “the” and “this,” for simplicity of illustration. An actual individual voice profile 143 or text-to-voice library 141 will advantageously include at least five hundred to one thousand words stored therein, and preferably several thousand words. In view of the fact that different morphologies of the same word (e.g. run, ran, runs, running) have different pronunciations, embodiments are envisioned wherein the personal voice profile for an average speaker will ideally include at least ten to twenty thousand separate entries. Moreover, the foregoing example shows each word represented only once. In an embodiment, a personal voice profile 143 may include multiple nuances of the same word, to capture the range of variation by an individual.

In FIG. 6A, each word is identified by the “proper spelling” such as might be represented by UNICODE. The second representation of the word is phonetic, preferably according to the digital code for the text portion 305 of the Universal Phonetic Alphabet 147. (See FIGS. 1 and 3). Regarding the phonetic representation of a word, it is important to remember that different speakers may have a different phonetic pronunciation are the same word. For example, the “normal” phonetic pronunciation of the word “this” could be phonetically represented by <th ï s>. However, an idiosyncratic “twang” of an individual speaker may phonetically render the word “this” as <th [symbol] -y ï s>. (The dash is intended to represent that there are two slightly distinct syllables. Those familiar with the concept of regional accents and human speech will immediately recognize that some “syllables” are shorter or less emphasized than others, so that the “twangy” rendition of the word “this” and he needs depicted above may really be closer to one-and-a-half syllables.) Such nuances can easily be represented within the Universal Phonetic Library (UPL).

In the foregoing example, in the generation of both words, the first line of text discloses that the “th” sound is found in the Universal Phonetic Library (UPL) at address UPL-67.

The schwa < [symbol] > in the word “the” is found at address UPL-23. Within the Individual Voice Profile 143 depicted above, the word “the” is typically followed by a pause of 215 ms.

The short “i”<ï> in the word “this” is found at address UPL-19, and the “s” sound in the word “this” is found at address UPL-104. Within the Individual Voice Profile Library depicted above, the word “this” is typically followed by a pause of 215 ms.

The code depicted in FIG. 6A is derived from the Universal phonetic Library of FIG. 3B. Alternative embodiments drawn directly from the Universal phonetic alphabet 147 of FIG. 3A are also envisioned. In such embodiment, frequency and duration are not inherent in a UPL address, and would be added to each line of code.

FIG. 6B depicts an alternative embodiment of the code in FIG. 6A in which a flexible range for a pause is indicated in the final line of the code. Embodiments are envisioned in which a pause takes place before, or after a word. The utility of FIG. 6B will be appreciated in the forthcoming discussion of morphological, syntactical and grammatical correlates which can influence the length of a pause before or after a word. Other embodiments are envisioned, however, in which no pause whatsoever is indicated in the code describing the audio reproduction word.

Acoustic Envelopes

In an alternative embodiment for generating a text-to-voice library 141 or a personal voice profile 143, the reader must first appreciate the concept of an acoustic envelope. An acoustic envelope is effectively a graph of volume versus time depicting a particular sound. The y-axis represents volume, and the x-axis represent time. In the embodiments described herein, and envelope is depicted as being a single uniform frequency, and further depicts the generation of overtones in a sound as being formed through the superposition of two or more acoustic envelopes of different frequencies. This depiction, however, should not be construed to limit the appended claims which envision alternative embodiments in which acoustic envelopes comprising a plurality of overtones and harmonics are generated in some manner other than superposition of independently defined acoustic envelopes.

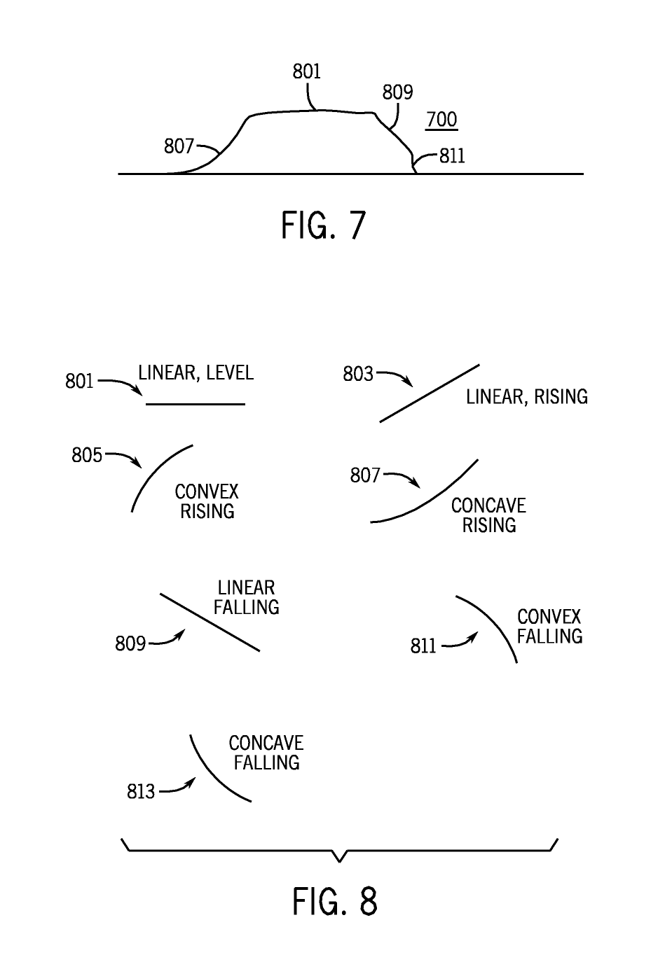

FIG. 7 depicts an example of an acoustic envelope 700. The frequency is unspecified.

FIG. 8 depicts seven distinct envelope fragments respectively numbered 801, 803, 805, 807, 809, 811, 813. In envelope fragment 801, the volume is at a substantially constant level over time. In envelope fragment 803, the volume of sound increases linearly over time. In envelope fragment 805, the volume increases over time, depicting a convex arch. In envelope fragment 807, the volume increases over time, depicting a concave arch. In envelope fragment 809, the volume decreases along a linear path. In envelope fragment 811, the volume decreases over time along a convex arch. In envelope fragment 813, volume decreases over time on a concave arch. Those skilled in the art will appreciate that, because sound is often measured on a logarithmic scale, the same slope may be depicted as linear, convex, or concave, dependent on the underlying equation representing the change in sound volume over time.

Those skilled in the art will readily appreciate that envelope fragments 803 through 813 may be further subdivided into subspecies. For example, a upward slope may be at a 45° angle, a 30° angle, a 60° angle, etc. The determination of how many of “sub-species” are represented within the voice profile library 119 will advantageously be determined by at least two factors. Firstly, psychological acoustics will measure the ability of the human ear to distinguish between envelopes exhibiting distinct shapes and slopes. Secondly, processing time, data storage and economic considerations will govern whether the benefits outweigh the costs when programming complexity is progressively increased.

Returning briefly to FIG. 7, the acoustic envelope 700 is seen to comprise the following sequence of envelope segments: increasing volume, concave 801; level 803; decreasing volume, linear 805; decreasing volume, convex 807.

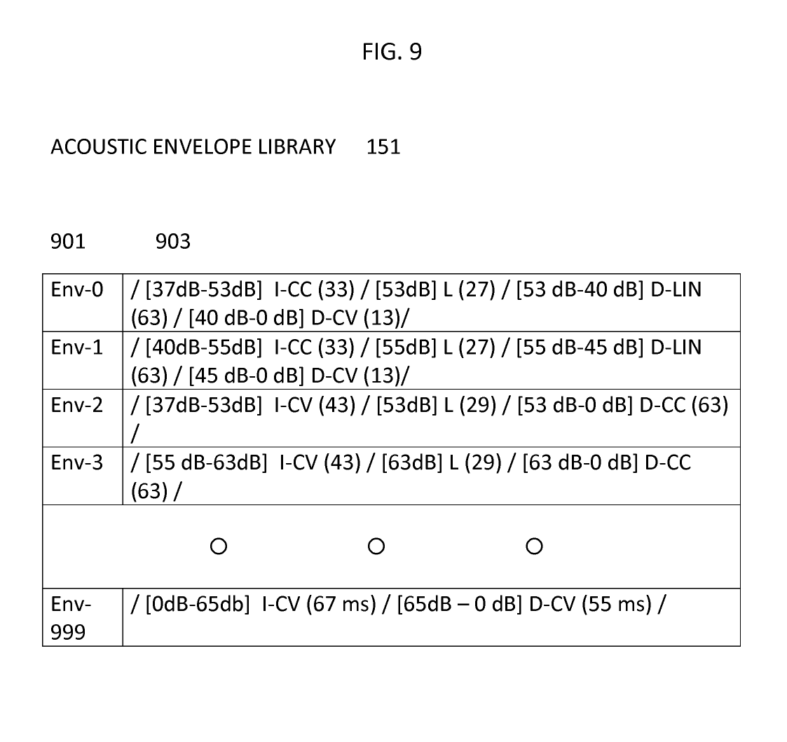

FIG. 9 depicts an acoustic envelope library 151 including a plurality of envelope addresses 901 corresponding to a respective plurality of digital expressions 903 which define the distinct characteristics of their respective acoustic envelopes. The envelope addresses are represented as Env-1 through Env-999. Throughout the examples used herein, the digital expressions defining the characteristics of a digital envelope are expressed in terms of a plurality of segments that form an envelope. This specificity is not intended to limit the appended claims, or application of the principles taught herein, which may use any useful programming language to facilitate the generation of an acoustic envelope having certain characteristics. The programming expressions may include, but are not limited to, information about the shape of the envelope, information about the shape of an envelope segment (e.g. linear, convex, concave, etc), information about the slope of a segment, information about the duration of the acoustic envelope or a component segment, and information about the volume or relative volume of the envelope, or one of the component segments.

For example, the digital code corresponding to address Env-0 depicts, in code, a representation of envelope 700 depicted in FIG. 7. The / marks delimit separate segments. The syntactical code for the first segment, /[37 dB-53 dB] I-CC (33)/ stands for “increasing volume, concave shape, raising from 37 dB to 53 dB the rising volume occurring over a period of 33 ms.” The second segment, /[53 dB] L (27)/ stands for “level volume at 53 dB for a period of 27 ms”. The third segment, /[53 dB-40 dB] D-LIN (63)/ indicates a portion of the envelope decreasing from 53 dB to 40 dB linearly over a period of 63 ms. The fourth segment, /[40 dB-0 dB] D-CV (13)/ indicates decreasing volume, convex in shape from 40 dB to 0 dB over a period of 13 ms.

The syntax depicted above is intended only as an example, and not intended to limit alternative embodiments of depicting various aspects of sound envelopes by digital text or code. Moreover, the foregoing example is not intended to limit alternative embodiments, including alternative degrees of Syntactical complexity. Those skilled in the art will appreciate that the syntax can be developed indicating the superposition of two or more acoustical envelopes of different frequencies.

For illustrative purposes, the Acoustic Envelope Library 151 of FIG. 9 is limited to one-thousand distinguishable acoustic envelopes corresponding to one-thousand consecutive addresses represented in base ten. This is hypothetical, and is not intended to limit the number of distinct envelopes within an acoustic envelope library according to actual application of the embodiments described herein.

Development of a Comprehensive Acoustic Envelope Library

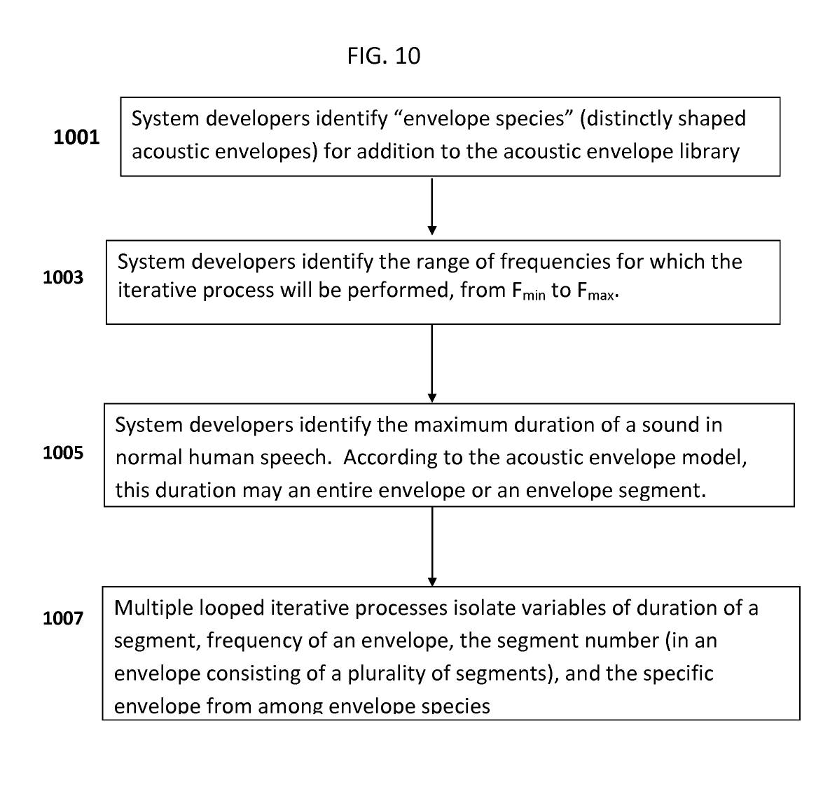

FIG. 10 depicts a method for developing the acoustic envelope Library 151 depicted in FIG. 9. The method essentially depicts the process of developing an acoustic envelope Library describing a plurality of envelopes varying frequency, variations in the fundamental shape of an envelope (i.e., the number of rises, falls, and the level sections), variations in the duration of those envelope segments, variations in the shape of each segment (linear, concave, or convex) and the slope of the respective segments.

Recalling the process in FIG. 4 whereby psychological studies are conducted to determine the sensitivity of human hearing for audio files 307 derived from the Universal Phonetic Alphabet 147 that combined frequency and duration to distinguish sounds, a similar psychological study is advantageously used to identify the limits of human hearing in distinguishing differently shaped envelopes, including the duration of an envelope segment, and the slope (rate of rise or fall) of an envelope segment. The size of the Envelope Library 151 will advantageously be large enough to represent enough envelope shapes that a hearer will not be able to detect slight changes from one envelope to another similarly shaped envelope, thereby covering the full spectrum of human speech, capturing the idiosyncratic nuances of an individual's speech patterns when generating an authentic Custom Synthetic Digital Voice Recording.

In step 1001, system developers identify distinctly shaped acoustic envelopes for addition to the acoustic envelope library. Distinctions include combinations and permutations of the three forms of segments, “up,” “down” and “flat,” as well as segment shapes such as convex, concave and linear, different slopes of envelope sections, etc. The number of variables in the description is limited for purposes of simplicity and comprehension of the process described herein.

In step 1003, system developers identify the range of frequencies for which the iterative process will be performed, from Fₘᵢₙ to Fₘₐₓ. The range of human hearing is generally in the range of 20 Hz to 20 kHz.

In step 1005, system developers identify the maximum duration of a sound in normal human speech. According to the acoustic envelope model, this duration represents the length of a segment of an envelope. However, the same process can be performed using the Universal phonetic alphabet 147, as previously discussed.

In step 1007, an iterative process begins isolating variables of duration of a segment, frequency of an envelope, the segment number (in an envelope consisting of a plurality of segments), and the specific envelope (from among the combinations and permutations of envelope structures defined in step 1001). Iterative processes are commonly known in the art. The size of the frequency increments and segment duration increments will be determined by studies in psychological acoustics such that a single increment is indistinguishable or nearly indistinguishable to the human ear, thereby ensuring that the full range of idiosyncrasies within human voices can be represented by the envelope forms contained in the Acoustic Envelope Library 151.

Generating a Text-to-Voice Library or Personal Voice Profile According to a Acoustic Envelope Embodiment.

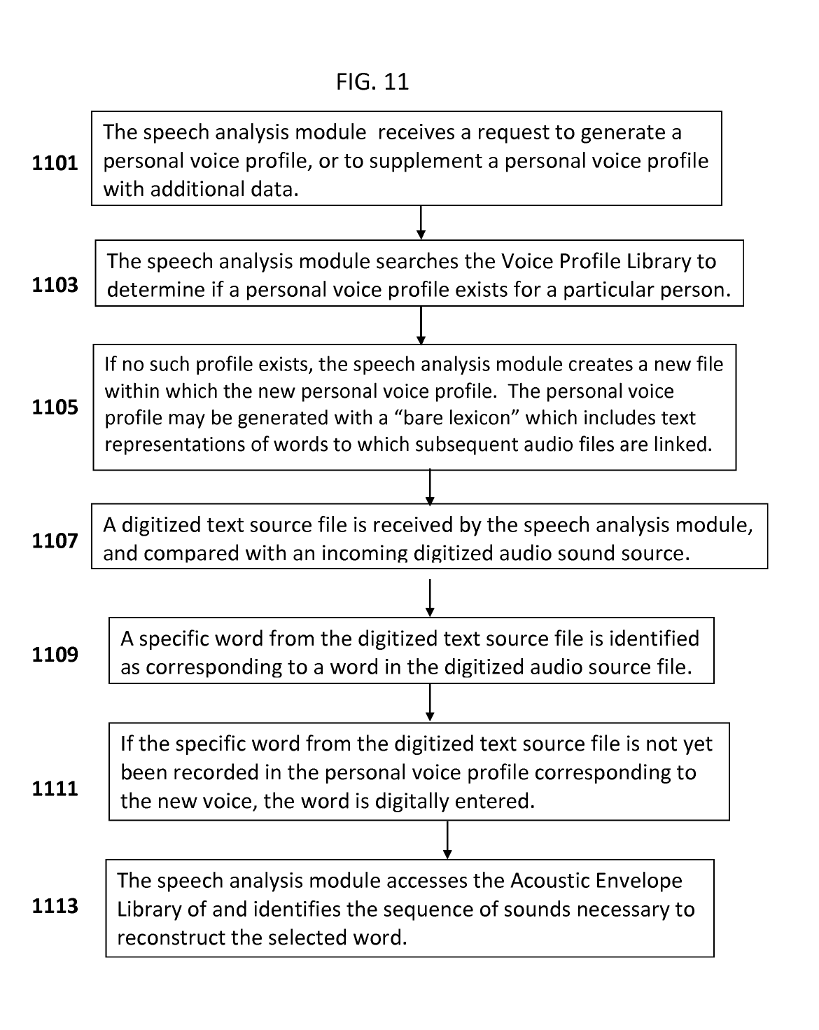

FIG. 11 describes a process for generating a general text-to-voice Library 141, and/or a personal voice profile 143, by combining discrete acoustic envelopes 700 defined in the acoustic envelope Library 151. Referring briefly to FIG. 1, the speech analysis module 101 combines multiple envelopes 700 defined in the Acoustic Envelope Library 151 to form specific sounds, preferably, though not necessarily, actual words which are listed in the general text-to-voice Library 141 or a personal voice profile 143. Word synthesis from fundamental envelope shapes includes, when necessary, the superposition of two or more sounds or sound envelopes during the same time frame, as well as forming audio files that sequentially combine multiple discrete acoustic envelopes.

After developing a general text-to-voice library 141 or a personal voice profile 143, in a subsequent operation, the integration module 125 accesses these text-to-voice libraries 141, 143 to generate custom synthetic digital voice recordings CSDVRS. However, it will be readily appreciated that the general text-to-voice library 141 or a personal voice profile 143 may not have every word represented within a specific text file 122 of the text library 121. Accordingly, alternative embodiments are envisioned wherein at least some of the words within a custom synthetic digital voice recording CSDVR are generated directly from Acoustic Envelope Library 151 “on the fly.” In a preferred embodiment, any new words which are generated “on the fly” during the generation of a CSDVR are also stored in the appropriate word libraries 143, 143 thereby reducing the overhead necessary to generate each word for future CSDVRs. Some of the specific examples below are described in terms of generating a personal voice profile 143. The reader will readily appreciate that the same process can be used in the formation of a general text-to-voice library 141 with very few changes.

In step 1101, the speech analysis module 101 receives a request to generate a personal voice profile 143, or to supplement a personal voice profile with additional data.

In step 1103, the speech analysis module 101 (or some other apparatus, module or application) searches the Voice Profile Library 119 to determine if a personal voice profile 143 exists for a particular person.

In step 1105, if no such profile exists, the speech analysis module creates a new file within which the new personal voice profile 143 will be stored. Embodiments are envisioned in which a newly generated personal voice profile (that is, an “empty” personal voice profile) includes a basic lexicon of words represented in text, as well as a “standard” phonetic spelling. The speech analysis module 101 is thereby able to store word sounds in predetermined digital fields which correspond to the textual representation of that word.

In step 1107, a digitized text source file 103 is received by the speech analysis module 101, and compared with an incoming digitized audio sound source 105.

In step 1109, a specific word from the digitized text source file 103 is identified as corresponding to a word in the digitized audio source file 105. To facilitate this correlation of written and spoken terms, the digitized text source file 103 will preferably include the phonetic spelling of every word according to the Universal Phonetic Alphabet 147, thereby enabling the speech analysis module to more accurately correlate spoken words to their respective text equivalents. The reader will therefore appreciate that a Universal Phonetic Alphabet 147 may be used in conjunction with the acoustic envelope embodiment 700 (FIG. 7), 151 (FIGS. 1, 9) with or without a universal phonetic library 149.

In an alternative embodiment of step 1109, a “bare lexicon” 153 is stored within the voice profile Library 119. The bare lexicon includes a standard spelling and phonetic spelling. In correlating words of the text to incoming audio files of individual words, the speech analysis module 101 accesses the bare lexicon to identify phonetic spelling of words, thereby more easily correlating the text to the audio file of a spoken word. This “bare lexicon” in actuality, may be an auto generated lexicon within a personal voice profile at its inception, as described in conjunction with step 1105.

In step 1111, if the specific word from the digitized text source file 103 is not yet been recorded in the personal voice profile 143 corresponding to the new voice, the word is digitally entered. Preferably the personal voice profile 143 is organized and easily searchable manner, such as alphabetical order.

In step 1113, the speech analysis module 101 accesses the Acoustic Envelope Library of FIG. 9 and identifies the sequence of sounds necessary to reconstruct the selected word. This envelope, or sequence of envelopes, preferably as represented by envelope address in column 901, is entered into the personal voice profile 143 in conjunction with the word being entered. After the incorporation of a sufficient number of audio files of words within a personal voice profile, the personal voice profile will have sufficient data to allow the integration module 125 to generate a custom synthetic digital voice recording of a selected text 122 in that person's voice.

Sample Syntax of a Text-to-Voice Library According to an Acoustic Envelope Embodiment

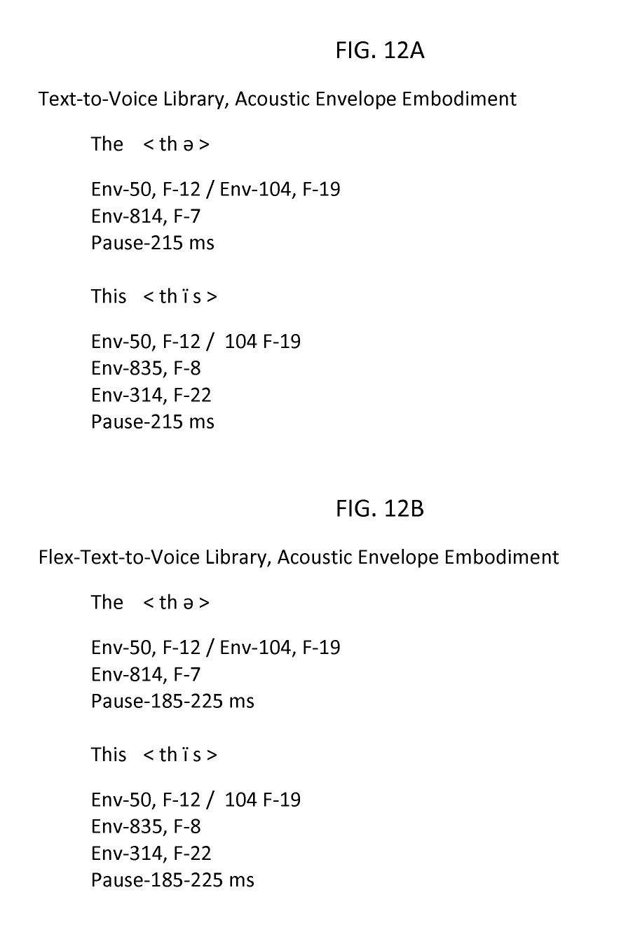

FIG. 12A depicts a Text-to-Voice Library according to an acoustic envelope embodiment. The code representing the library in FIG. 12 can be used in conjunction with the General Text-to-Voice library 141 or a Personal Voice Profile 143.

The reader will appreciate that FIG. 12 comprises only two words, “the” and “this.” An actual voice profile Library in an individual will advantageously include at least five hundred to one thousand words stored therein, and preferably all of the words necessary to reproduce a selected written text in narrative form. As an increasing number of source files 103 are examined by the speech analysis module 101 of FIG. 1, and converted to audio format in the voice of a particular speaker, any new words within the text will advantageously be generated in the voice of a particular speaker and added to his or her Individual Voice Profile 143.

In the Acoustic Envelope Embodiment of library entries of FIG. 12A, each word is identified by the “proper spelling” and the “phonetic spelling.” As discussed above in conjunction with the Universal Phonetic Library 147 (FIG. 1, 3B) embodiment, it is important to remember that different speakers may have a different phonetic pronunciation are the same word.

According to the sample code depicted in FIG. 12, both of the sample words “the” and “this” disclose a first line of text in which frequency no. 12 is generated in the shape of the envelope defined at envelope address 50, and frequency no. 19 is generated in the shape of the envelope defined at envelope address 104. These two acoustic envelopes are super-positioned upon each other to form the “th” sound for both the word “the” in the word “this”.

The schwa < [symbol] > in the word “the” is produced by generating frequency No. 7 according to the acoustic envelope defined at envelope address 814. Within the Individual Voice Profile 43 depicted above, the word “the” is typically followed by a pause of 215 ms.

The short “i”<ï> in the word “this” is produced by generating frequency No. 8 according to the acoustic envelope defined at envelope address 835. The “s” sound in the word “this” is produced by generating frequency No. 22 according to the acoustic envelope defined at envelope address 314. Within the Individual Voice Profile 143 depicted above, the word “this” is typically followed by a pause of 215 ms.

FIG. 12B is a flexible embodiment of text-to-speech code which includes a flexible range of envelope sizes and a range of pauses. It is otherwise identical to FIG. 12A.

Alternative or Combined Acoustic Envelope and Universal Phonetic Library Embodiments

Although the “Universal Phonetic Library” embodiment 149 and the “Sound Envelope library” embodiment 151 (FIG. 1), 900 (FIG. 9) are envisioned an alternative techniques for generating a CSDVR, embodiments are envisioned in which the generation of a CSDVR incorporates any combination of techniques described with both of these techniques.

Volume, Relative Volume, and Psychological Acoustics

The range of the human ear can generally detect sounds ranging from 20 Hz to 20 kHz. However, the human ear is generally most “sensitive” to sounds falling in the range of 1 kHz to 4 kHz. In the word “this,” the “s” sound is normally at a much higher frequency than the vowel. If the entire word “sounds” (psychologically speaking) to be at approximately a constant volume, in reality, any sounds falling outside the 1 kHz to 4 kHz range (e.g. the “s” sound) will have to be at a much higher volume in order to sound as loud as the vowel. Accordingly, embodiments are envisioned which identify “relative” volume of certain sounds. Using, for example, the Universal Phonetic Library embodiment, if a vowel and an “s” sound were produced at identical volumes, the word may sound distorted to the human ear. Accordingly, to “sound” normal, the “s” sound in a certain word may have to be 5 dB above the arbitrary norm for the volume established for A-440. Throughout this disclosure, therefore, the reader will appreciate that any line of code may be augmented to include a dB “offset”. For example, let us assume that “A 440” (440 Hz, the frequency used as a starting point my many piano tuners) is used as the “baseline” and arbitrarily assigned a volume of 65 dB. All other sounds may be assigned a negative or positive “offset”, for example, of −3 dB or +5 db relative to the baseline volume of “A 440”. This offset may be inferred in examples where it is not specifically shown.

Morphological, Syntactical, and Grammatical (MSG) Correlates

A General Text-to-Voice Library or an Individual Voice Profile may include multiple entries of the same word pronounced differently, and/or statistical correlates of particular morphological, syntactical, or grammatical (MSG) structures which are related with a different pronunciation. Consider the following two sentence fragments:

1) “I said to him [pause 1] that he should . . . ” and

2) “I therefore said to him [pause 2] that he should . . . ”

Human speech has a rhythm, and that rhythm is affected by many morphological, syntactical and grammatical nuances within a particular sentence. In the foregoing example, many speakers would increase the duration of [pause 2] compared with [pause 1] because of the presence of the word “therefore.”

The following MSG list is not intended to be comprehensive, but to represent a sampling of MSG variables which may be considered in the formation of a personal voice profile 143.

MSG Abbreviation List

Gen=General pronunciation (absent any of the particular grammatical or syntactical correlates for the same sound or word. This represents a baseline pronunciation from which deviations are measured.)

### S=Sentence

TC=Temporal Clause (e.g., “when I go to the store”)
CC=Concessive clause (e.g. beginning with “notwithstanding,” although,” “inasmuch as,” “to the extent that,” “accepting that,” “conceding,” “acknowledging,” “in view of” etc.)
CDC=Conditional Clause (“if”)
CONC=Conclusory Clause (Governed by “therefore,” “accordingly,” “thus,” “hence,” “ergo,” “consequently,” “as a consequence”
CP=Clause of privation (“without,” “apart from,” “in the absence of,” “in lieu of,” etc.)
RC=Relative clause (beginning with a relative pronoun)
CausC=Causal Clause (beginning with “because,” “as a result of,” or a circumstantial participle).
SBC=Subordinate Clause (a clause subordinate to a conditional clause, a temporal clause a relative clause, a conditional clause, etc., e.g. “When I go to the store, I always stop for lunch.)
BW/X=Beginning word of X (wherein X is a sentence, a conditional clause, etc. and wherein X is also defined by the code as illustrated above)
n/X=n^{th} word of clause or sentence X
EW/X=End word of clause or sentence X
n/EW/X=n^{th} word from the end of clause or sentence X

### P=Preceding

### F=Following

AB=Antecedent basis (e.g. the word is used earlier in the sentence, or in a preceding sentence.

### W=Word

### V=Vowel

### C=Consonant

CONT=Conclusory Term (“therefore,” “accordingly,” “thus,” “hence,” “ergo,” “consequently,” “as a consequence”

### Not=not

PN=pronoun (I, me, you, he, she, him, her, it, we, us, they, them).
RP=relative pronoun (who, whom, which)
PP=possessive pronoun (his, hers, whose)
DP=demonstrative pronoun (this, these, that, those)

### IA=Indefinite Article (a, an)

sw=Same Word
sc=Same Clause
DS=Different speaker

### G=Governing

Inf=infinitive verbal form

### Subj=Subject

### DO=Direct Object

### IO=Indirect Object

### TV=Transitive Verb

### IV=Intransitive Verb

MD=Mood (indicative, imperative, interrogative, subjunctive, etc.)
CS=Case (Nominative, Accusative, Dative, Instrumental, Genitive, Vocative, Prepositional, etc.—typically varies from language to language.

### VT=Verb Tense

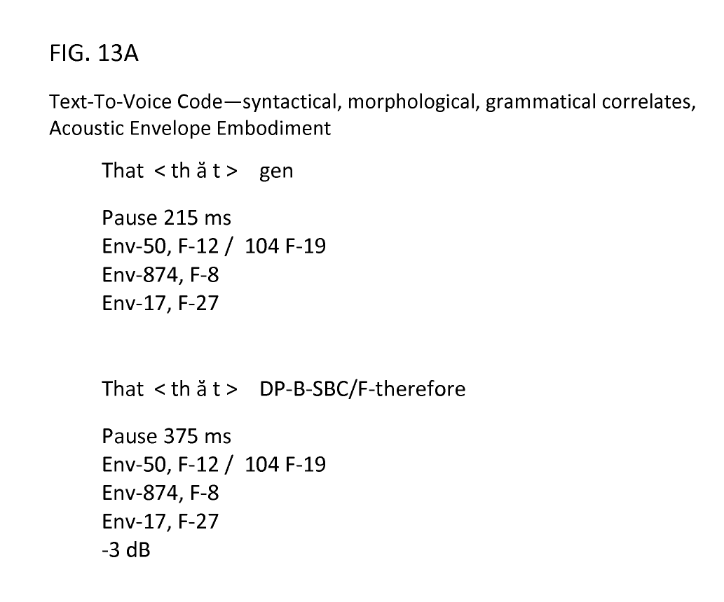

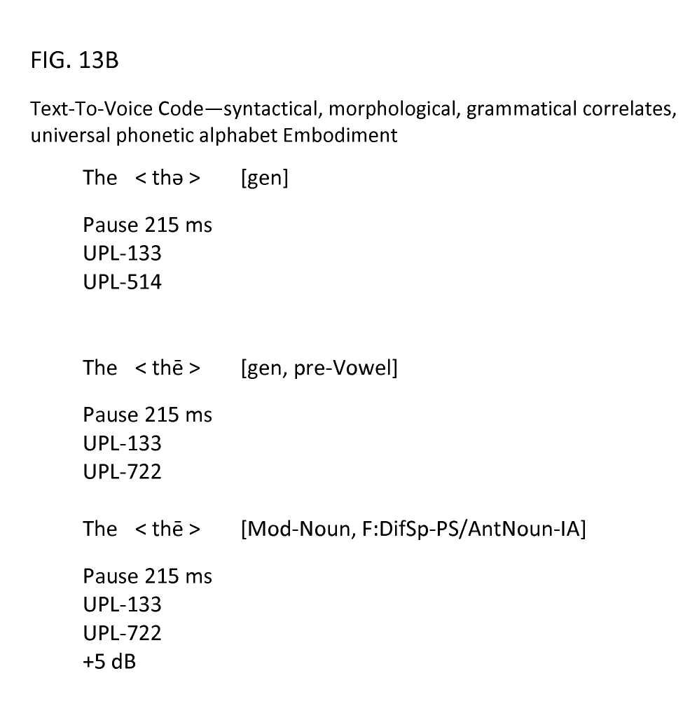

FIGS. 13A and 13B disclose examples of syntactical code which might be utilized within a text-to-voice Library 141, 143. Referring to FIG. 13A, and recalling the foregoing example, wherein the demonstrative pronoun “that” was followed by a longer pause when it began a clause subordinate to the word “therefore,” the voice profile library could be expanded to include alternative pause lengths preceding this term. The first line of code for a particular word can incorporate the particular morphological correlate or nuance governing the pronunciation. Consider the following two entries of the term “that.”

For convenience, FIG. 13 utilizes the “Audio Envelope” embodiment. Those of ordinary skill in the art will appreciate that this technique could readily be applied to code representing sounds in the “Universal Phonetic Library” embodiment. Multiple entries for a specific word reflect the differences in pronunciation, pause length, etc., as a function of SMG correlates.

Still referring to FIG. 13, the first line of each word includes the actual text representation (e.g., the Unicode spelling of the word “that”), a phonetic spelling <th \check{a} t>, and an MSG correlate. In a hypothetical Individual Voice Profile depicted above, the word “that” is listed twice. The listings are identical except for the MSG correlate, and the pause preceding the pronunciation of the actual word.

The first representation of the word “that” within the individual voice profile is the “general” or “baseline” characterization of this word, identified by “gen,”. This indicates that, for the hypothetical speaker, a pause of 215 ms normally occurs before this word is spoken.

The second representation of the word “that” when used in conjunction with the MSG correlate DP-“B-SBC/F-therefore.” It's volume is 3 dB lower than the “baseline” use of the word “that,” and there is a longer pause (375 ms) preceding the word. According to the MSG profile, this extended pause and slightly lower volume occurs when the word “that” is a demonstrative pronoun (DP) located at the beginning (B) of a subordinate clause (SBC) when that subordinate clause follows (F) the word “therefore.”

FIG. 13B depicts similar MSG code modifying entries in a text-to-voice library using universal phonetic library embodiment. There are two pronunciations of the word “the.” A first pronunciation utilizes the “schwa” vowel sound, (th [symbol] ), and the second pronunciation uses a “long-e” pronunciation, (thē). Both pronunciations are listed in a voice-to-text library 141, 143.

The first entry of FIG. 13B depicts the “schwa” pronunciation <th [symbol] > used in general circumstances [gen] in the English language.

The second entry of FIG. 13B depicts the long-e pronunciation <thē>. The SMG correlate identifies this pronunciation as preceding a vowel [pre-vowel].

The third entry of FIG. 13B also depicts the long-e pronunciation <thē>, but is further modified by an increase in volume of 5 dB. The MSG correlates associated with this pronunciation requires that the word modifies a noun [Mod-Noun] which follows [F] a different speaker [DifSp] in a previous sentence [PS] wherein the antecedent usage of the noun [AntNoun] was identified by an indefinite article [IA]. Consider the following exchange—Speaker 1: “Are you a director of this operation?” The presence of the indefinite article before the word “director” can be construed to mean that the speaker assumes there are many directors. Speaker 2: “I am thē director of this operation.” One familiar with English will appreciate that, when speaker 2 repeats the information of speaker 1 with no variation except the presence of the definite article, the message is a corrective. The second speaker is not one of many directors (as suggested by the first speaker), he is either the only director, or, at least, the principal director. In such circumstances, the second speaker will use the “long-e” in the definite article to stress the unique importance of his directorship. The MSG circumstances giving rise to this variation in pronunciation are defined in the text-to-voice library of FIG. 13B.

Because there are a virtually unlimited number of morphological syntactical and grammatical variables within a sentence, and some are more likely than others to correlate with distinguishable pronunciation or cadence of the speaker, a method needs to distinguish the most statistically relevant MSG correlates from the statistically irrelevant.

Method for Generating a Text-to-Voice Library Incorporating Morphological, Syntactical and Grammatical Correlates

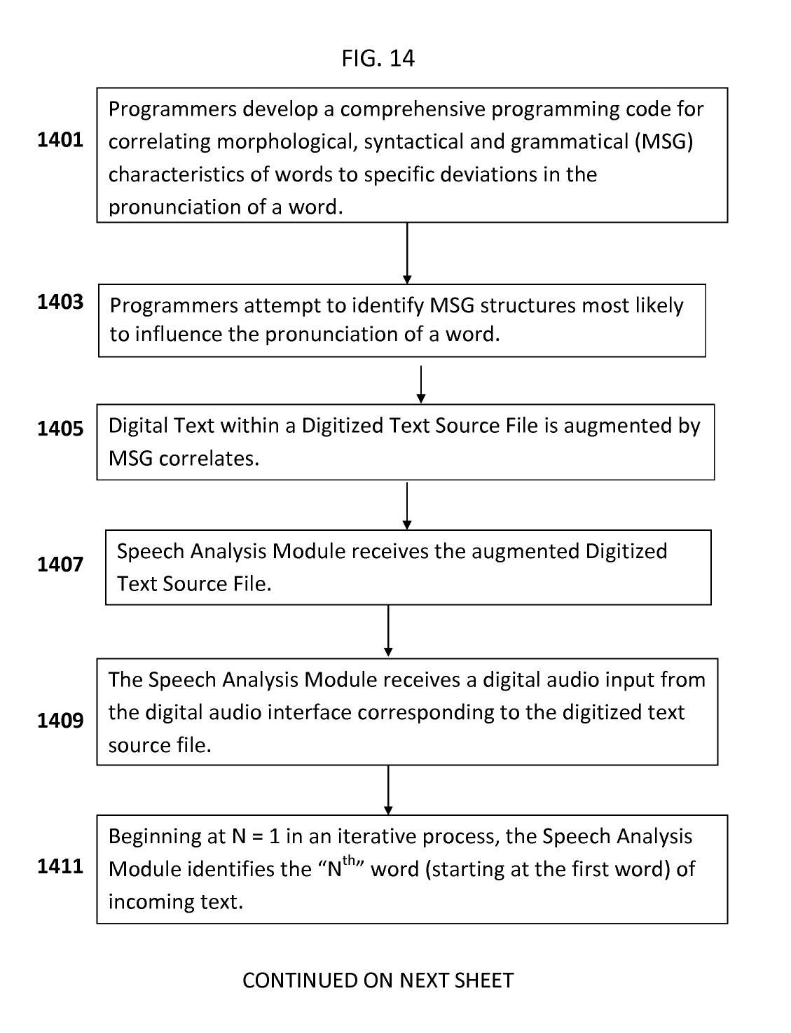

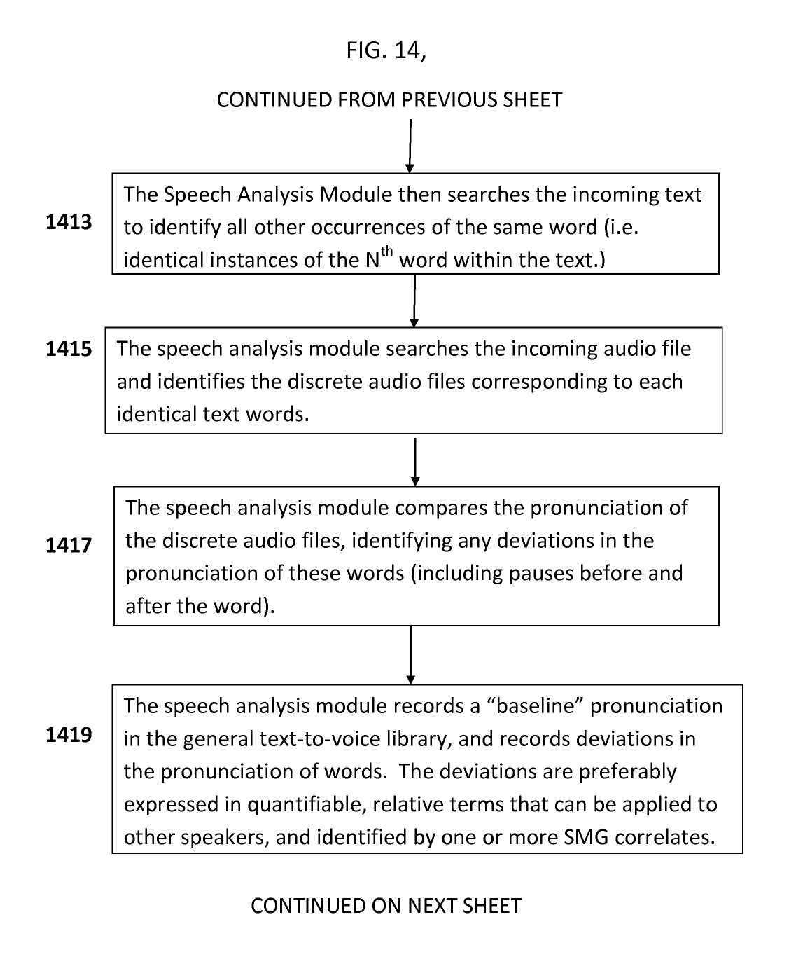

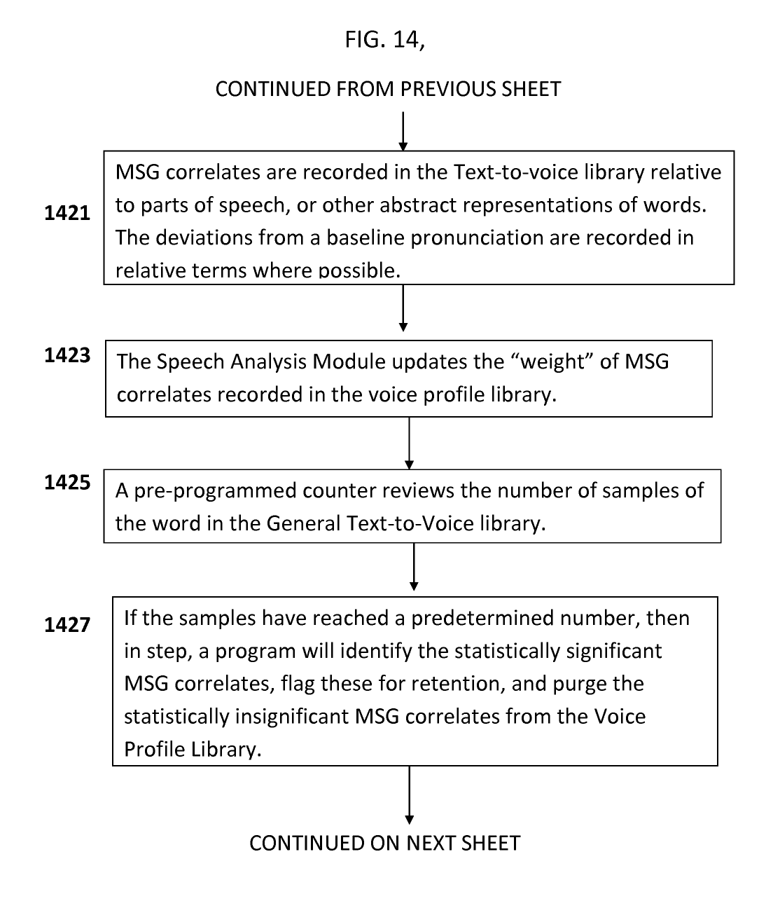

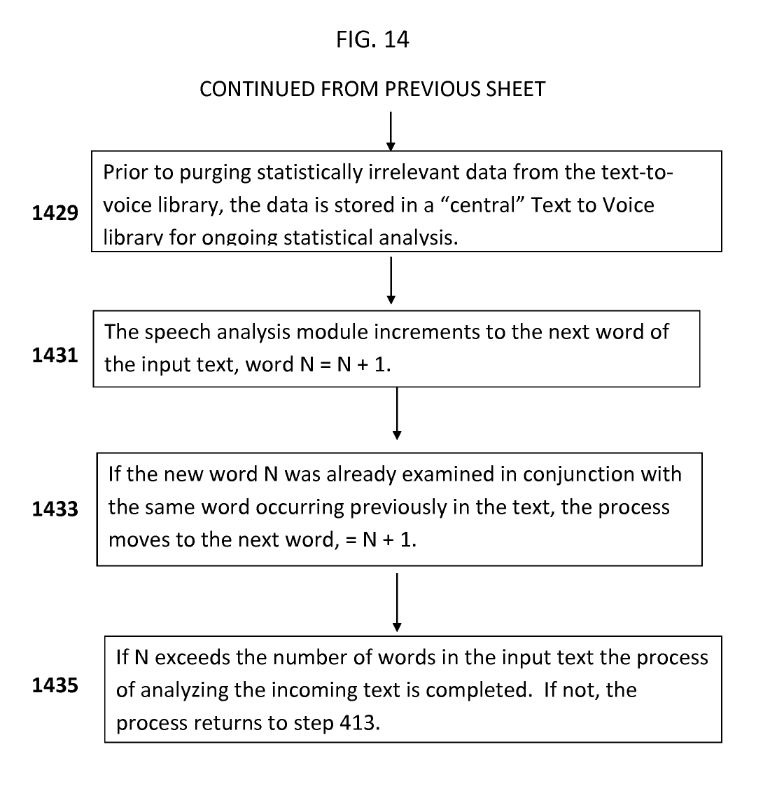

FIG. 14 depicts a method for generating a voice profile library 119 with a view toward incorporating SMG correlates. For simplicity, the process is described in terms of generating the General Text-to-Voice library 141, but may be utilized in developing a personal Voice Profile 143 as well. The process revolves around identifying statistically significant MSG correlates, and also for limiting the number of MSG correlates stored in the Voice Profile Library 119.

In step 1401, programmers developed a comprehensive programming code for correlating morphological, syntactical and grammatical (MSG) characteristics of words to specific deviations in the pronunciation of a word. This includes both the “MSG vocabulary,” which, in an embodiment, may utilize the collection of abbreviations such as the MSG Abbreviation List shown above, and the syntax of a programming code necessary to efficiently define multiple MSG correlates in a single written expression which can operate within a digital program. FIGS. 6, 12 and 13 depicted examples of such code. For example, in FIG. 13, the phrase “DP-B-SBC/F-therefore” illustrated an example of a syntactical structure defining the pronunciation of the demonstrative pronoun “that” at the beginning of a subordinate clause which followed the word “therefore”.

In step 1403, programmers attempt to identify MSG structures most likely to influence the pronunciation of a word, or the lack of a pause preceding or following the word. Although there is virtually no limit to the number of “MSG correlates” that can be distilled from a text, those skilled in the language arts and familiar with the nuances of a particular language will be able to identify MSG correlates which are most likely to influence the pronunciation of various words, and the cadence the spoken language, including pauses, raising and falling of volume, pitch, etc. This process may be complemented by an automated program that generates MSG structures for use in analyzing variations of the spoken language in view of these MSG structures, cataloging those MSG structures which demonstrate a statistical correlate to alternative pronunciation.

In step 1405, text input within a Digitized Text Source File 103 is augmented by MSG correlates. This is to say, within the text of a digitized text source file, various abbreviations are interspersed, defining parts of speech, types of causes, and other grammatical and syntactical nuances. An example of an augmented text might include, “The [B-S, DA, No Ant.] quick [Adj 1 of 2] brown [adj 2 of 2] fox [Sub, sing] jumped [IV-PT] over [Prep] the [DA, No Ant.] lazy [Adj] dogs [noun, obj-prep].” In this augmented text, the expression [B-S, DA] which modifies the first word, “The” means “beginning Sentence, definite article, no antecedent basis.” The expression [Adj 1 of 2] modifying the word “quick” means “adjective 1 of 2”. The expression [adj 2 of 2] modifying the word “brown” means “adjective 2 of 2.” The expression [sub, sing] modifying the word “fox” means “subject, singular.” The expression [IV-PT] modifying the word “jumped” means “intransitive verb, past tense.” The term [Prep] modifying the word “over” means “preposition.” The expression the [DA, No Ant.] modifying the definite article “the” means “definite article, no antecedent.” The expression [Adj] modifying the word “lazy” means “adjective.” The expression [noun, obj-prep] modifying the word “dogs” means “noun an object of a preposition.” By augmenting a digitized text source file 103 in this manner, the text can be more easily analyzed for statistically significant correlates between variations in spoken language and MSG structures.

In a preferred embodiment, the augmentation is performed automatically by a smart program. Embodiments are envisioned, however, wherein such MSG correlates are inserted by a programmer.

In step 1407, the Speech Analysis Module 101 receives the augmented Digitized Text Source File 103, such as depicted in step 1407, and identifies all the distinct word used within the text. In an embodiment, the distinct words are organized alphabetically so that they can be systematically analyzed by the speech analysis module. Assume, for example, the word “A” occurs fifteen times, the word “abstract” occurs once, the word “an” occurs four times, etc. For illustrative purposes, the first word in the alphabetical arrangement is defined as “N.”

In step 1409, the Speech Analysis Module 101 receives an input signal from the digital audio interface 105 corresponding to the digitized text source file 103.

In step 1411, beginning at N=1 in an iterative process, the Speech Analysis Module 101 identifies the “N^{th}” word (starting at the first word) of incoming text.

In step 1413, the Speech Analysis Module then searches the incoming text to identify all other occurrences of the same word (i.e. identical instances of the N^{th} word within the text.

In step 1415, the speech analysis module searches the incoming audio file and identifies the discrete audio files corresponding to each use of the N^{th} word within the written text.

In step 1417, the speech analysis module compares the pronunciation of the discrete audio files, identifying any deviations in the pronunciation of these words (including pauses before and after the word), and the SMG correlates which might be responsible for affecting the pronunciation, are categorized in a table. Using the foregoing example of the word “that,” consider that the Speech Analysis Module 101 identifies nine separate usages of the word “that.” Eight are preceded by a pause of 209 ms to 224 ms, with a mean of 215 ms. The pause preceding one use of the term “that” falls outside this standard deviation, being 375 ms. As noted in the foregoing illustration, this was because the clause was subordinate to the word “therefore.”

Although programmers familiar with a language can program the speech analysis module to consider specific MSG correlates, the speech analysis module cannot “know” why this deviation exists. Therefore, a “dumb” program within the speech analysis module may identify two or even twenty MSG correlates as potential reasons for the abnormally long pause. Only by the gathering of additional statistical correlates can the incorrect or irrelevant correlates be thrown out.

One of the nine occurrences of the word “that” is at a higher frequency. Recall from the foregoing example that the “a” sound in “that” was represented by Envelope no. 874 at a frequency of F-8. In sampling the vocal input, one occurrence of the word “that” conforms to envelope no. 883, which is similar in shape to envelope 874, but has a slightly longer duration. Additionally, the tone is at a higher frequency, specifically F-12. Although experience may tell us that the higher-pitched sample of the word “that” is due to the facts that the word follows word “and,” and occurs in the final clause of a paragraph, the actual clause was “and that, my friends, is the end of the story.” Again, however, the Speech Analysis Module 101 does not “know” which of the MSG correlates is the cause of the higher pitch and slightly longer duration. So multiple MSG correlates may be stored. In an embodiment, to ensure that acoustic variations in speech are properly correlated to various MSG nuances, programmers may listen to an audio input, and “suggest” potential MSG correlates. The generation of a Text-to-Voice library with MSG correlates may therefore be performed by programmers, semi automated, or fully automated. However, even in an automated process, the gathering of enough data will confirm which correlates are statistically relevant, and which are statistically irrelevant.

In step 419, the speech analysis module records the “baseline” pronunciation in the general text-to-voice library 141, and deviations from the baseline pronunciation along with the MSG correlates which may correspond to that deviation. Preferably, the deviations are defined in abstract terms. For example, for one speaker, the baseline pronunciation of a sample word may be at frequency F-22 out of thirty possible frequencies, and, in a given grammatical setting, the frequency may drop three levels, to frequency F-19. Because another speaker with a higher voice may have a baseline frequency of F-18, it would not be meaningful to record the aberrant pronunciation as frequency F-19. Rather, it would be meaningful to record it as three measures lower than the baseline frequency. Accordingly, in the general text-to-voice library, more important than sample audio files are the deviations from the normal pronunciation of a word, those deviations being expressed in quantifiable terms that can be applied to other speakers and other voices.

As discussed above, at the inception of the formation of the text-to-voice library 141, system programmers advantageously identify multiple MSG correlates known through human experience to affect the pronunciation of a word. Because a single word may have more than twenty MSG correlates, and further, because only certain combinations and permutations of those MSG correlates are relevant to affecting speech, in a preferred embodiment, the text-to-voice library 141 is prefilled with MSG correlates believed to be relevant to the pronunciation of certain words or parts of speech. According to this embodiment, aberrant pronunciations of words recorded within the text-to-voice library 141 are only correlated to MSG circumstances that are deemed potentially relevant. As discussed below, however, a “central” data base can record a higher number of MSG circumstances and perform continual “number crunching” and statistical analysis to update and enhance the relevant MSG incidents recorded in the text-to-voice library 141.

Abstract MSG Correlates

In an embodiment, in step 1421, MSG correlates are recorded in the Text-to-voice library relative to parts of speech, or other abstract representations of words. The deviations from a baseline pronunciation are recorded in relative terms where possible. Using the foregoing example, the word “that” is a demonstrative pronoun, the following abstract correlate is added to the General Text-to-Voice library.

### DP=B-SBC/F-therefore

### +Pause 100 ms

### Env (831-860), F +2

### Env (8-49) F +3: 13<F<22

−3 dB

The meaning of the foregoing code is: When a demonstrative pronoun (DP) occurs at the beginning of a subordinate clause (B-SBC) which follows the term “therefore” in a preceding clause (/F-therefore), find the “general” formula for audio reproduction of the particular word (e.g. the word “that”), and make the following alterations. 1) Increase the pause before the demonstrative pronoun by 100 ms compared with the “baseline” example of this same word; 2) increase by two “notes” (which may be any frequency gradation, and not necessarily related to the “notes” on our “eight note scale”) the tone of any sounds formed according to any of sound envelopes 831-860, 3) for any of envelopes from addresses 8-49 which are filled with frequencies greater than frequency no. 13, but less than frequency no. 22, increase the tone by three notes; and decrease by 3 dB the general volume of any word fitting the MSG profile.

Although there are only about four demonstrative pronouns in English, “this, these, that, and those,” it can readily be appreciated that there are hundreds of other parts of speech, such as nouns, verbs, adjectives and adverbs. A general “abstract” rule governing demonstrative pronouns may not save much space, or reduce overhead time by much. But the same abstract MSG rules, when applied to nouns or other common parts of speech, can reduce the memory consumption and overhead profoundly. Imagine, for example, that 350 MSG rules are eventually discovered which modulate the audio reproduction of nouns. And further imagine for simplicity same that there are 1,000 nouns in a language. The same set of 350 rules would have to be repeated a total of 350,000 times if repeated individually for each noun. In contrast, only 350 rules are needed when generally applied to nouns. Accordingly, abstract MSG correlates can reduce overhead time and the consumption of processing power.

Statistical Weighting by Frequency of Occurrence

In step 1423, the Speech Analysis Module 101 updates the “weight” of MSG correlates recorded in the voice profile library 119. Assume, for example, that within the Voice Profile Library 119 there are already one hundred forty seven “general” samples of the word “that” in the General Text-to-voice library 141. Because there are eight new “general” occurrences of the word “that,” the number in the Voice Profile Library 119 is incremented by eight, to one hundred fifty-five. Various MSG correlates may also be stored in conjunction with this “general” pronunciation, thereby recording which MSG correlates do not affect the pronunciation of a word.

Within the Voice Profile Library 119, assume further that there are twelve MSG correlates which show a statistically longer pause before the word “that” when it begins a subordinate clause governed by the word “therefore.” In view of the data collected by the speech analysis module 101, this number is incremented by one.

Other statistical correlates are envisioned for both the general text-to-voice library 141 and the personal voice profile 143. For example, if the same construction is observed multiple times by an actual speaker (e.g. the demonstrative pronoun governed by the word “therefore,”) statistical notes can be kept in the personal voice profile such as “6 of 9,” demonstrating that, out of six times this construction was observed by a given speaker, two thirds of the time, a longer pause was incorporated before the demonstrative pronoun “that.” Similarly, the same statistic, “6 of 9” can be maintained in the general text-to-voice library 141. This statistical information can be considered when generating a custom synthetic digital voice recording. The value of such information in the general text-to-voice library is particularly significant when there is no audio record of a given speaker actually using such a word or using it in such a grammatical construction. Synthetic generation of individual words in a personal voice profile 143 can be augmented by such statistical information.

It is important to remember that separate data must be kept for an actual speaker. For example, a “synthetic” pronunciation of a word in a given grammatical circumstance may be generated and stored in the personal voice profile of an individual. However if there is no recorded incident of him or her actually speaking the statistical representation of a given pronunciation in the personal voice profile must be “0 of 0.”

Extrinsic and Intrinsic Factors Affecting Pronunciation

Extrinsic factors (education, country, city and state of origin, year of birth, age at the time of the speech, etc.) may be recorded and used to consider whether the increased pause length is appropriate an orator. For example, one gifted in oratory is more likely to increase the pause before the demonstrative pronoun “that” when governed by the word “therefore,” than one not gifted in oratory. Intrinsic factors, such as fluent use certain uncommon words, expressions or constructions, may also be observed to affect the pronunciation of a word. Abbreviations of these extrinsic and intrinsic factors will advantageously be developed by system programmers, and reference to these extrinsic and intrinsic factors will advantageously be incorporated within the general text-to-voice library 141 to further enhance the accuracy of artificial reproduction of an individual's speech patterns.

In the present example, there are eight MSG correlates for the increased pitch of the word “that” when it occurs in the final clause of a paragraph and follows the word “and.” This number is also incremented by one, showing nine such MSG correlates.

Other MSG correlates may also be recorded. In an embodiment, if an MSG correlate shows no “statistical bulge” after significant sampling of that word, it may be purged, or isolated, as described below.

In step 1425, a pre-programmed counter reviews the number of samples of the word “that” in the General Text-to-Voice section 141 of the Voice profile library 119.

In step 1427, if the samples have reached a predetermined number, then in step 821, a program will identify the statistically significant MSG correlates, flag these for retention, and purge the statistically insignificant MSG correlates from the Voice Profile Library 119. At that point, the General Text-to-Voice section 141 will be “mature” with respect to the word “that,” and will reject further input.

In step 1429, prior to purging statistically irrelevant data from the text-to-voice library, the data is stored in a “central” Text to Voice library (not shown). The “general” text to voice library 141 is used to generated custom synthetic digital voice recordings, and to assist in generating personal voice profiles. To be effective in this, its size cannot become unwieldy or it will consume unnecessary processing power. However, an ongoing program of statistical analysis is maintained in a central text-to-voice library. Because the only purpose of this library is to identify new potential MSG correlates, and the probability (frequency) with which those conditions affect the pronunciation of a word, extreme size and consumption of processing power does not affect the generation of custom synthetic digital voice recordings.

The aggregate data and “number crunching” in the central text-to-voice data base is periodically re-examined to determine if any new statistically significant MSG correlates have developed. If any new statistically significant MSG correlates are observed in conjunction with any words, those new correlates are added to the “limited” Text to Voice Library 141 to enhance the quality of text-to-speech conversions.

In step 1431, the speech analysis module increments to the next word (N=N+1). If the new word N was already examined in conjunction with a previous occurrence of the same word in the incoming text, the word was advantageously flagged at that time, and the process increments again, N=N+1. If N+1 exceeds the number of words in the incoming text, the analysis of the incoming text is completed. If the new word N has not been previously examined, and does not exceed the number of words in the incoming text, the process returns to the step 1413.

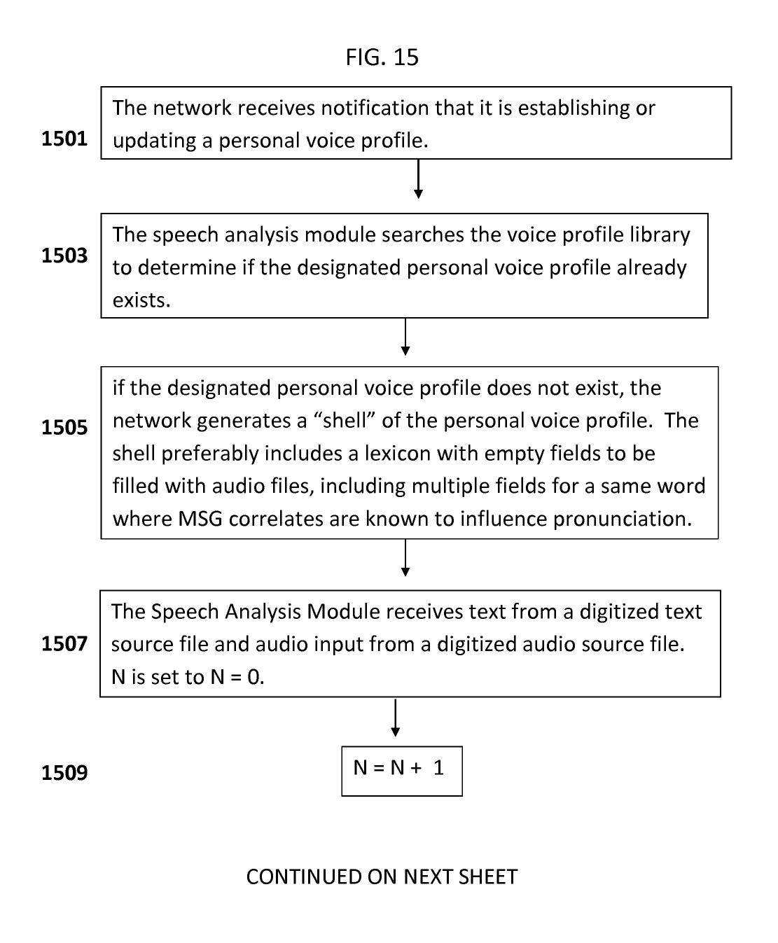

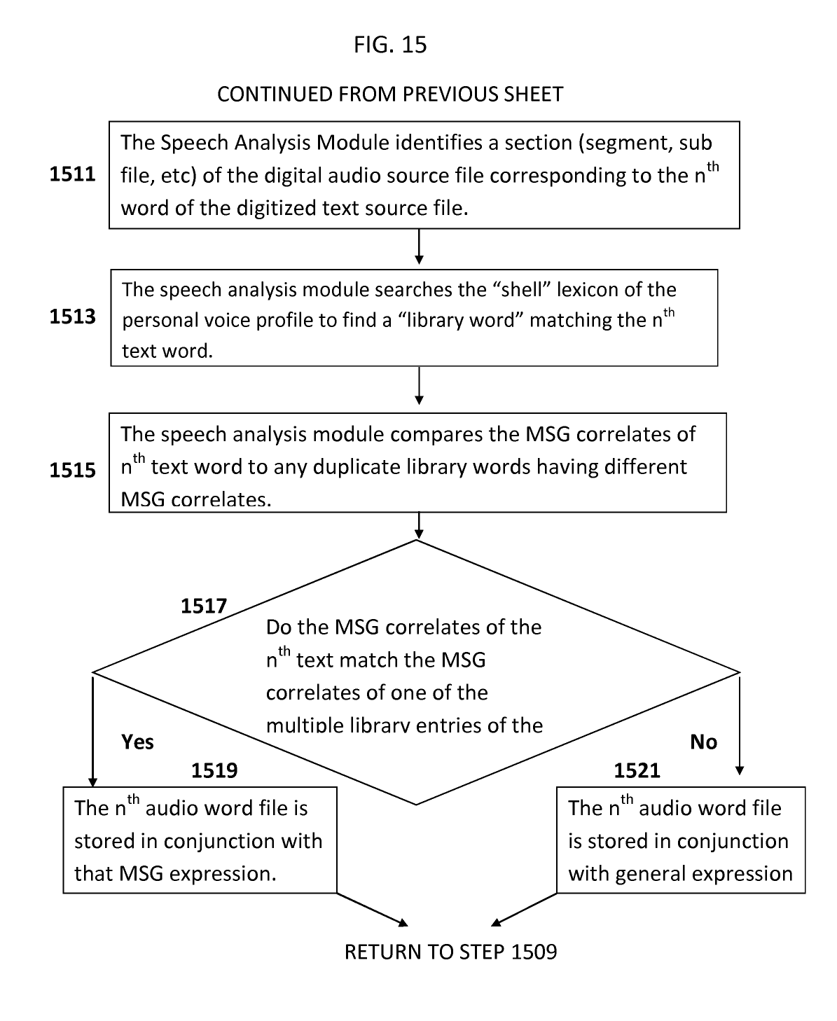

FIG. 15 describes the process for formulating (or updating) a Personal Voice Profile 143. The reader will appreciate that, concurrent with the formulating (or updating) of an Individual Voice Profile, the speech analysis module may also be updating the General Text-to-Voice Library. The process of FIG. 15 is substantially identical to the process of FIG. 14. It is more efficient, however, in that no automated program searches for “new” text-to-voice correlates. Only the existing correlates in the General Text to Voice Library are repeated in the Individual Text-to-Voice Profile 143.

In step 1501, the network receives notification that it is establishing or updating a personal voice profile 143.

In step 1503, the speech analysis module 101 searches the voice profile library 119 to determine if the designated personal voice profile 143 already exists.

In step 1505, if the designated personal voice profile 143 does not exist, the network generates a “shell” of the personal voice profile. Advantageously, this shell will include a lexicon of at least some of the words of the language. Even more preferably, wherein a word is presented multiple times according to within the general text-to-voice profile 141, the shell will include entries (fields to be filled with digital audio files) for known MSG correlates of each word.

In step 1507, the speech analysis module receives text from the Digitized Text Source File 103 and an audio input from the digitized audio source file 105, the and resets the value of n=0. In an embodiment, the digitized text 103 has been augmented by MSG correlates before being received by the speech analysis module 101, however, augmentation may be performed by the speech analysis module itself.

In step 1509, n=n+1

In step 1511, the Speech Analysis Module 101 identifies a section (segment, sub file, etc) of the digital audio source file 105 corresponding to the n^{th} word of the digitized text source file 103. (The audio sub-file is hereinafter referred to as the n^{th} audio word file.) The reader will appreciate, however, that the n^{th} audio word file may comprise a portion of a word, or, alternatively, a contraction, expression or group of words.

In step 1513, the speech analysis module 101 searches the “shell” lexicon of the personal voice profile 143 (or, if such a shell has not been generated, the general text-to-voice library 141) to find a “library word” matching the n^{th} text word.

In step 1515, the speech analysis module 101 compares the MSG correlates of n^{th} text word to any duplicate library words having different MSG correlates.

In step 1517, if the MSG correlates of the n^{th} text match the MSG correlates of one of the multiple library entries of the n^{th} text word, then in step 1519, the n^{th} audio word file is stored in conjunction with that library word.

In step 1517, if the MSG no MSG correlates in a matching library word can be found to match the MSG correlates of the n^{th} text word, then, in step 1521 the n^{th} audio word file is stored in the library in conjunction with the “general” expression of the library word.

The reader will appreciate that, if an audio word file has already been stored under a specific entry in the personal voice profile, and a new match if found for the same library entry, the audio words can be compared. If a deviation exists between the two audio word files, the deviation may be attributed to deviations within the pronunciation of words matching the MSG correlates of the dictionary entry. Alternatively, the deviations may be due to additional MSG correlates which may not have even been identified in the general text-to-voice file 141. The extent of the deviation may be recorded in a statistical data base which is subject to ongoing statistical analysis to determine if other relevant SMG correlates exist which affect the pronunciation of words and expressions.

The reader will appreciate that some orators may pause in a predictable manner under certain grammatical constructions, whereas, for the “man on the street,” no such pause is present. In such a case, for a particular personal voice profile, if there were no deviation between the pronunciation of a word correlated to one SMG incident, and the same word correlated to another SMG incident, the same audio word file may be stored under both SMG incidents of that word.

In step 1523, the process returns to step 1509 and examines the next word in the incoming digitized text source file.

A Personal Voice Profile 143 may include both individual words, and abstract MSG correlates directed at specific parts of speech or grammatical constructions, as described in conjunction with the process of FIG. 14.

Content Addressable Memory and Efficient Search Algorithms

Regardless of whether the same rules are repeated only 350 times for abstract parts of speech, or 350,000 times for multiple words, those skilled in the art will readily appreciate that an efficient review of Morphological/Syntactical/Grammatical correlates (MSG correlates) can be time consuming, and the process of text-to-voice conversion can consume a great deal of processing power. To reduce the overhead time used in reviewing the relevant MSG correlates and rules, embodiments are envisioned which utilize technology found in “Content Addressable Memory” which involves the discharge of a match line if a match is not found, terminating a search, and eliminating the waste of further processing resources. Examples of content addressable memory technology can be seen, inter alia, in U.S. Pat. No. 7,852,653, which is incorporated herein in its entirety. According to a preferred embodiment, the MSG correlates will follow an orderly system that can be most quickly searched for correlates by families and sub-families in a predetermined order of MSG terms. By this way, when a “dead end” is reached in a search, the greatest number of other MSG correlates can be skipped, having been eliminated. Upon determining that a correlate does not exist, the algorithm will preferably eliminate the largest number of possible MSG correlates to reduce the consumption of processing power.

Generating a Custom Synthetic Digital Voice Recording

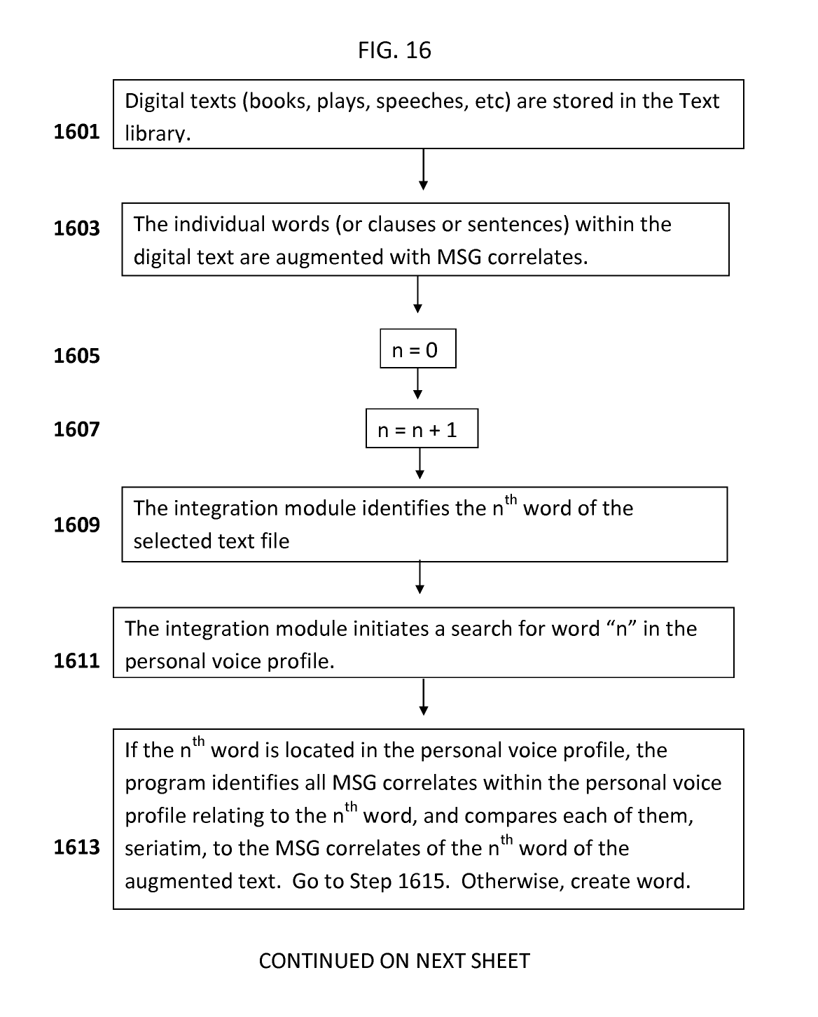

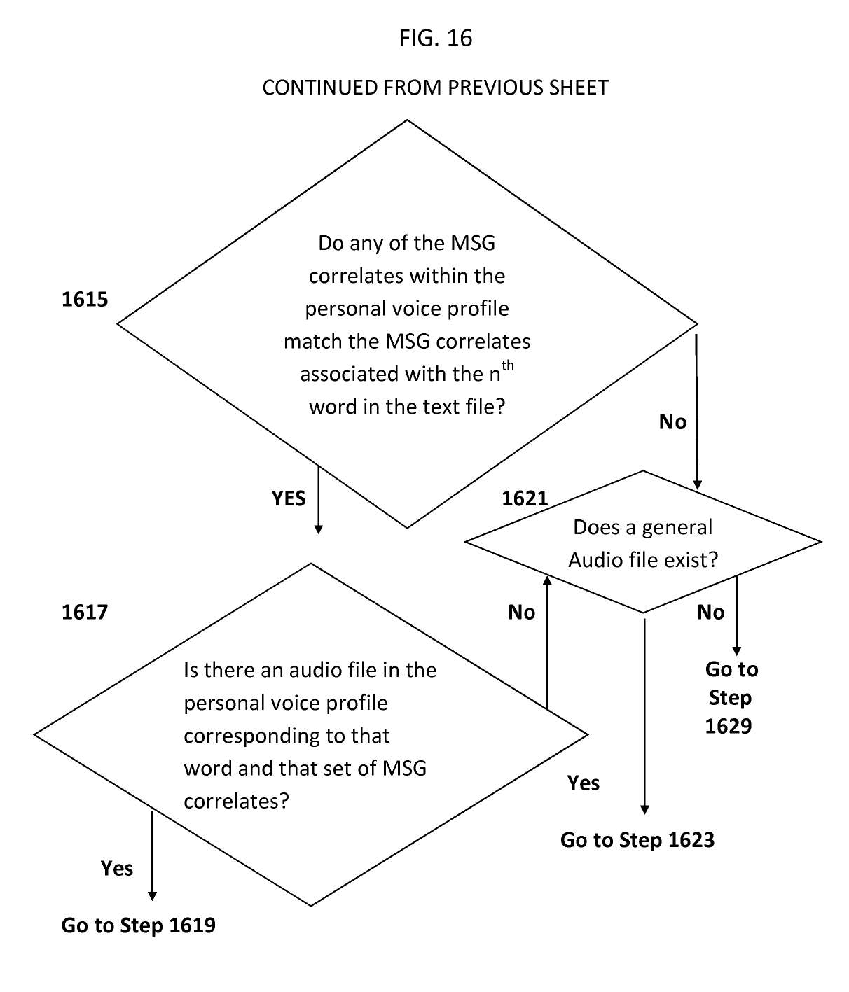

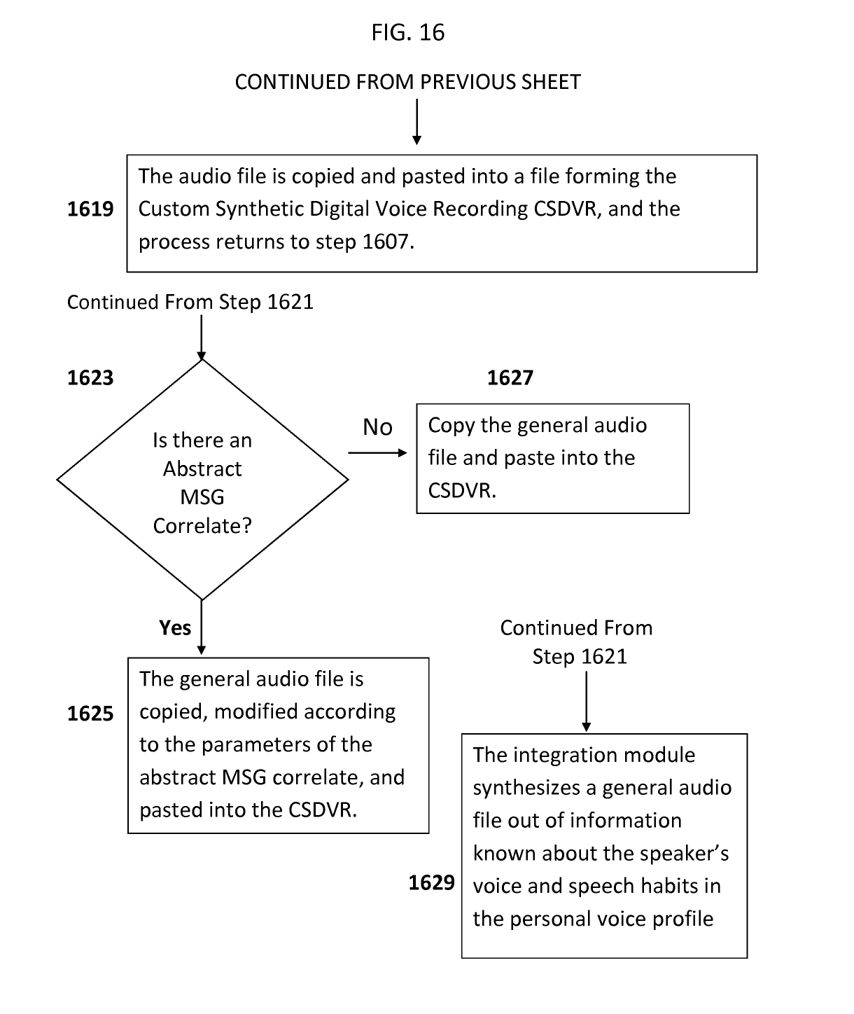

FIG. 16 describes the method for generating a custom synthetic digital voice recording from the apparatus described above. The process described in FIG. 16 assume that the personal voice profile 143 and the general text-to-voice library 141 have already been developed.

In step 1601, digital texts 122 (books, plays, speeches, etc) are stored in the Text library 121.

In step 1603, the individual words (or clauses or sentences) within the digital text 122 are augmented with MSG correlates. The process described in step 1407 of FIG. 14 for augmenting the text of a digitized text source 103 can advantageously be used in conjunction with augmenting the text digital texts 122.

In step 1605, the value n is set to n=0.

In step 1607, n=n+1. By this iterative counting, the generation of a CSDVR will advance through consecutive words of the text 122 being converted into an audio file. However, other iterative processes are envisioned. For example, after the generation of an audio file of a word, and the copying of that audio file into the CSDVR, the process can simply advance to the next word in the text of 122.

In step 1609, the integration module 125 identifies the n^{th} word of the selected text file 122. For example, the text file may be George Washington's farewell address. In the twenty-fifth iteration, n=25, and the module identifies the twenty-fifth word of George Washington's farewell address.

In step 1611, the personal voice profile 143 is searched to see if the n^{th} word is stored in the personal voice profile. As discussed above, the personal voice profile is advantageously arranged alphabetically, or in some other manner which enhances the efficiency of searching for specific words.

In step 1613, if the n^{th} word is located in the personal voice profile 143, the program identifies all MSG correlates within the personal voice profile 143 relating to the n^{th} word, and compares each of them, seriatim, to the MSG correlates of the n^{th} word of the augmented text.

In step 1615 if any of the MSG correlates within the personal voice profile 143 match the MSG correlates associated with the n^{th} word in the text file 122, then, in step 1617, the integration module searches for an audio file corresponding with the MSG correlate.

In step 1619, if the audio file of step 1617 is found, then the audio file is copied and pasted into the custom synthetic digital voice recording. the sound file 307 of FIG. 3B or 903 of FIG. 9) corresponding to that particular MSG correlate is copied and pasted into a file forming the Custom Synthetic Digital Voice Recording CSDVR. The process returns to step 1607.

In step 1615, if no audio file is present in the personal voice profile matching the word and MSG correlates of word “n,” then, in step 1617, the program searches for a “general” audio file corresponding to word “n.”

If, in step 1621, a general audio file is located, then in step 1623, the integration module 125 searches for an abstract MSG correlate.

If, in step 1623, an abstract MSG correlate is found, then in step 1625, the general audio file is copied, modified according to the parameters of the abstract MSG correlate, and pasted into the CSDVR.

In step 1623, of no abstract MSG correlate is found, then in step 1627, the general audio file of word “n” is copied and pasted into the CSDVR.

In step 1621, if no general audio file is located in the personal voice profile, then in step 1629, the integration module synthesizes a general audio file out of information known about the speaker's voice and speech habits. In the universal phonetic library embodiment, this can be achieved by identifying words which have been spoken by the selected narrator, identifying phonetic sub-portions of those words, and constructing other words according to the known characteristics of the speaker's voice.

It can be readily appreciated from step 1629 that the personal voice profile 143 of a person will advantageously contain not only words, but a subset of the universal phonetic library. It can be further appreciated that, if a particular phonetic sound such as the “short i” in “this” is pronounced with a “twang” such as “the-yis”, such accents can be used as a template for incorporating other idiosyncratic nuances of a speaker's voice during the generation of words which have not been recorded by the speaker. For this reason, even though a speaker's words may be recorded with the universal phonetic alphabet, the same words are advantageously recorded in the voice profile library 119 according to the “dictionary” phonetic pronunciation. By this feature, the “standard” phonetic pronunciation will establish a yardstick of how far the regional accent has deviated from it the standard pronunciation. This information can be utilized in the synthetic generation of new words by a speaker which have not been actually recorded from live speech.

Sales and Marketing

Existing models for selling digital files are envisioned in conjunction with the present invention. This includes payment by credit card, debit card, “PayPal” and other online money transfer programs, as well as revolving credit and cash. Distribution of CSDVR files may be through any known means of distributing digital information, including, but not limited to, the internet, wireless connections, or distribution kiosks, as taught in U.S. Pat. No. 7,779,058, which is incorporated by reference in its entirety herein. Additionally, embodiments are envisioned wherein storage media (such as a DVD) are distributed in the sale of CSDVRs.

The price of a custom voice recording may be dependent on a variety of factors, including, but not limited to, the length (file size) of the text being converted to voice, the data storage method (digital, analog vinyl press, etc), the digital protocol and compression ratio of the audio file being digitally generated, noise reduction and other technical enhancements used in conjunction with the file generation, existing copyrights on the text being converted into voice. Additionally, royalty costs associated with using a particular voice to generate the custom voice recording, and royalty payments to author will be accounted for in the pricing schemes.

Appropriate records are made of the text and voices used in the transaction, and royalty fees are paid to the copyright holder of the text, and to person or entity possessing rights to the voice selected for the recording. These royalty fees may be distributed directly from the distributor to the copyright holder of the text, and the holder of rights to the voice, or may be distributed through an intermediary licensing agent, such as ASCAP (American Society of Composers, Authors and Publishers) BMI (Broadcast Music Incorporated) and SESAC, or the quasi-governmental licensing agencies which are more common to Europe.

Watermarking and encryption techniques may optionally be employed to reduce widespread distribution of pirated sound recordings. Examples of such watermarking and encryption techniques are described in U.S. Pat. No. 7,779,058 issuing on Aug. 17, 2010 to Shea, which is incorporated herein in its entirety.

It can readily be appreciated that certain artificially generated voice recordings will be requested on a regular basis. For example, frequent requests might be entered for an audio rendition of “The Gathering Storm” in the actual voice of Winston Churchill. In view of the processing resources needed to produce such a sound recording, and further in view of the time necessary to generate such a sound recording, according to a preferred embodiment, a tracking module 133 reviews how often the same custom voice recording has been requested. If, multiple requests are frequently entered for the same custom voice recording, then the custom voice recording is “archived” (stored in a predetermined data base 135 for retrieval in subsequent requests). By this process, the overhead and time necessary to generate a custom voice recording can be avoided for commonly requested voice recordings.

Just as MP3 files can be “ripped” at different quality levels, resulting in different file sizes, it is envisioned that different artificially generated sound recordings could be generated at different levels of audio quality, utilizing greater or fewer processing parameters. Although files of different quality may not exhibit different file sizes, they may consume differing processing resources during the generation process. In view of this possibility, embodiments are envisioned wherein popular sound recordings (those archived for future use) are generated at the highest audio quality, taking into consideration a higher number of generational parameters.

Artificial Generation of Un-Acquired Words

The phonetic representation of words will enable the artificial reconstruction of words for which there is no record of the speaker's voice.

As discussed above, most speakers will not read an entire dictionary to offer samples of how they pronounce every word, so the pronunciation of many words will have to be reconstructed artificially. Additionally, statistical habits of the speaker himself are advantageously taken into consideration in the artificial reconstruction of words. If only one phonetic spelling exists, only one digital audio file is generated. If multiple phonetic spellings exist, according to one embodiment, the statistically “most likely” pronunciation is selected for the audio representation of the word. According to an alternative embodiment, the minor variations in pronunciation are selected according to a frequency commensurate with their statistical prominence, thereby replicating the minor variations in speech exhibited by human beings.

In one embodiment, proprietary rights are maintained over the speech analysis module 101, and/or the integration module 125. However, such modules can be eventually duplicated by programmers who are able to make and use the embodiments described herein, making restriction of such technology almost pointless. Moreover, many legitimate (lawful) use of speech analysis module 101 and integration module 125 are easily envisioned. For example, a mother may want to voice recordings of letters by a child's father who was lost in war. A father going on extended military duty may want to prepare a personal voice profile PVP of his own voice, or at least record his voice reading a predefined text so a personal voice profile can be generated as a subsequent time. This would allow a mother to prepare oral children's stories read in the voice of her husband while he was on military duty. A person may want to generate an audio recording of the King James Bible in the voice of his own father or mother. Because no copyright exists on the King James Bible, and a person owns their own voice, no royalty fees would properly be charged in such a circumstance. The only appropriate fees would be the licensing fees for use of the technology necessary to generate such sound recordings.

In view of these legitimate uses, it is doubtful that statutory prohibitions on the public availability of a speech analysis module 101, and/or the integration module 125 could withstand legal scrutiny in most countries. Such digital modules will therefore likely be available installation on personal computers.

Within the foregoing detailed description, many specific details have been presented in conjunction with processes, algorithms parameters and apparatus used to artificially generate from written text, a narrative audio file in the voice of a particular speaker. These specific details have been offered to more clearly illustrate the concepts described herein, and are not intended to limit the scope of the appended claims.

Multi-Voice Generation of a Custom Synthetic Digital Voice Recording

In embodiments described above, the generation of a custom synthetic digital voice recording included controlling the pitch of sounds, duration of sounds, volume of sounds, and pause between sounds, by “morphological, syntactical and grammatical correlates” (FIGS. 13A, 13B, 14, 15, 16) that capture the oratory style of an individual speaker. There are, however, multiple problems with this approach. First, it is resource intensive, both in terms of programming, and in terms of processing power needed to implement such a program. Secondly, recorded speeches or samples of someone's voice may contain only a hand full of the morphological, syntactical and grammatical correlates truly required to apply to a new text to create a quality synthetic digital voice recording.

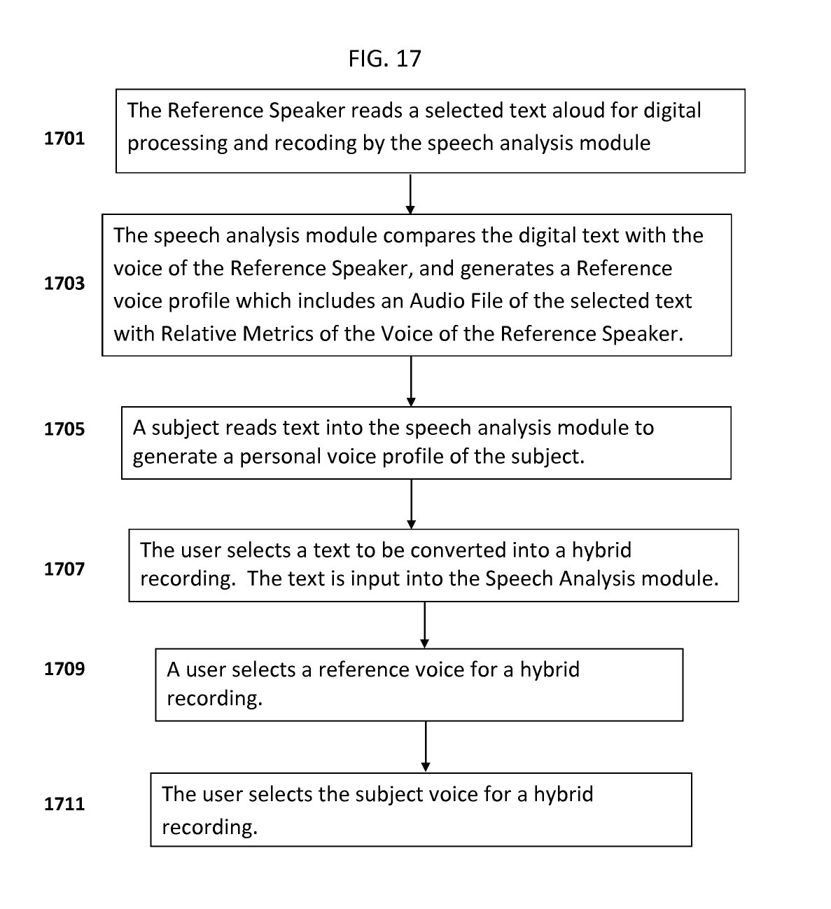

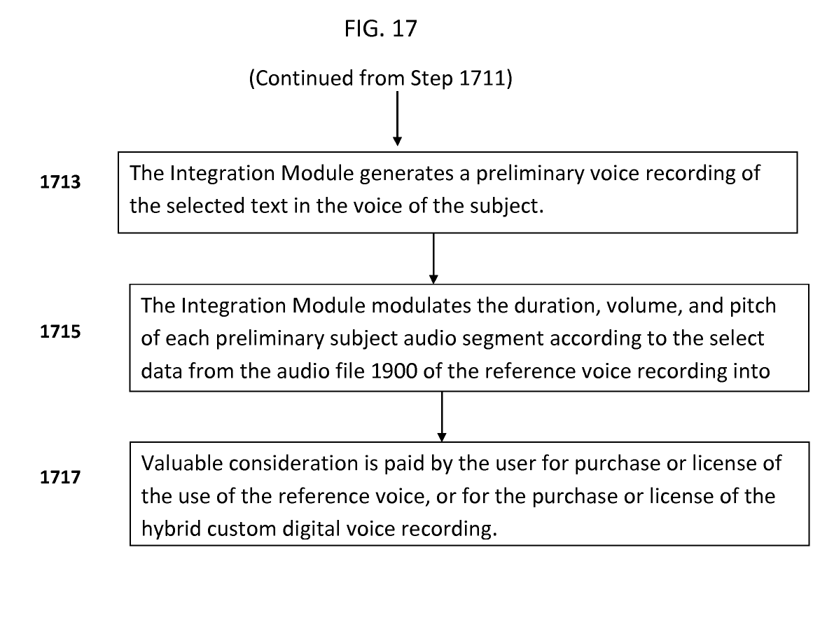

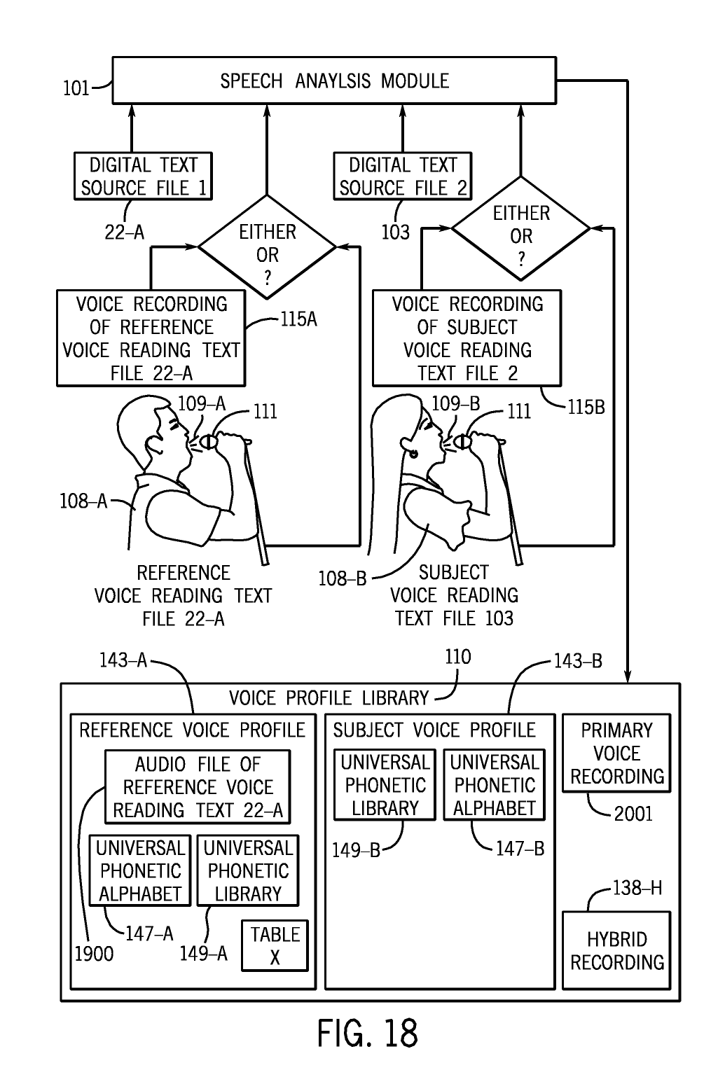

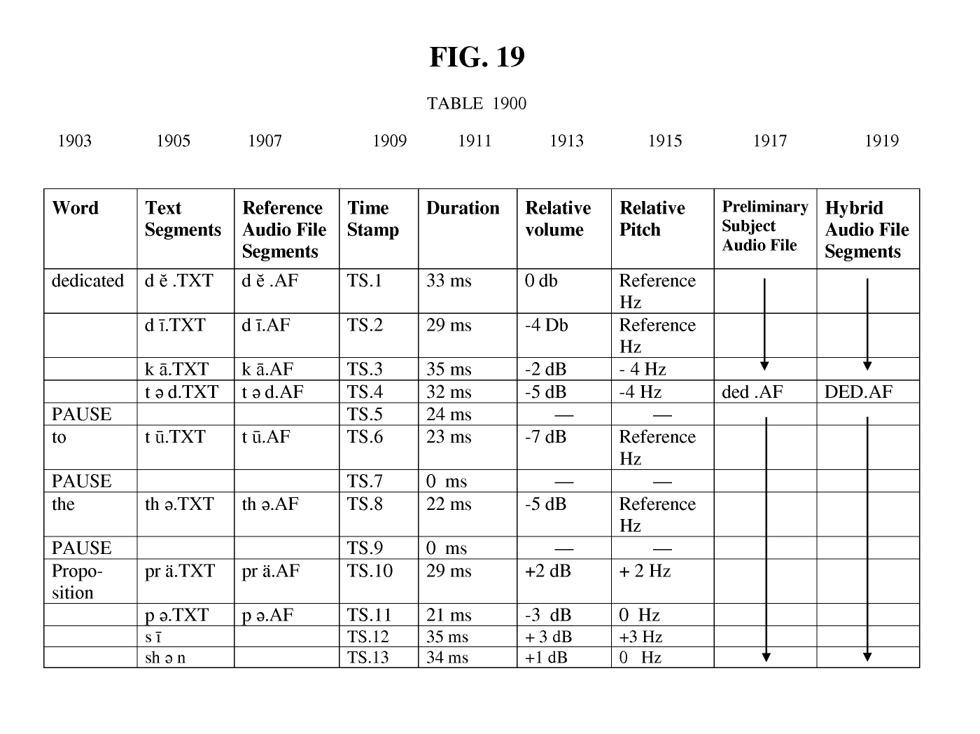

FIGS. 17, 18 and 19 depict an alternative method and apparatus for regulating the pitch, meter, and volume of individual sounds or syllables within a custom synthetic digital voice recording. The method and apparatus include two speakers, a reference speaker, and a subject speaker. The reference speaker 108-A is preferably a skilled speaker or gifted orator such as a Shakespearean actor. Aspects of his speech which will be imported into the final hybrid custom synthetic digital voice recording 138-H (FIG. 18, c.f. columns 1909, 1919 of FIG. 19, and include the “rise and fall” in volume and pitch, the duration of a syllable, or the duration of a pause. Aspects of the “subject's” 108-B voice 109-B (FIG. 18) used to form the final voice recording include the subject's idiosyncratic pronunciation of a language. In a sense, a hybrid recording will sound like the subject speaker after he or she had been coached in public reading or speaking.

In step 1701, a user selects a voice as a reference voice. As noted, this could be an accomplished orator, public speaker, or Shakespearian actor. It could also be a speaker who had studied the speech rhythms of Churchill, and therefore, could speak in the “style” of Churchill.

Consider a custom synthetic digital voice recording of the Gettysburg Address which could be represented in digital text 22-A (FIG. 18) and vocally recited by a reference speaker 180-A (FIG. 18). The Gettysburg Address recites, in part, “Four score and seven years ago, our fathers brought forth on this continent a new nation, conceived in liberty, and dedicated to the proposition that all men are created equal.”

Referring to FIG. 18, the reference speaker 108-A recites a narrative corresponding to a select digital text source file 22-A. The speech analysis module 101 generates an audio file 1900 as depicted in FIG. 18 (bottom left) discussed in greater detail in FIG. 19.

Referring to FIG. 19, column 1903 of Data Table 1900 contains the words of text of the digital text source file 22-A (FIG. 18) such as the Gettysburg Address. Column 1905 contains, text segments “TXT” which represent portions of the corresponding word in column 1903. The text segments 1905 may be as small as individual sounds of the Universal Phonetic Alphabet, or, as depicted in the example of FIG. 19, whole syllables.

In step 1703 of FIG. 17, the speech analysis module 101 (FIG. 18) compares the selected text 22-A (FIG. 18) with the voice of the reference speaker 109-A (FIG. 18), and generates the Reference Audio Recording (FIG. 19, columns 1903, 1905, 1907, 1909, 1911, 1913 and 1915) of the selected text. Each of the Audio File Segments 1907 (“AF”) represents the reference voice and corresponds to the text segment 1905 in the same row. Each row of the data table 1900 is identified by at least one identifier, such as a time stamp “.TS” 1909, or some other means of distinguishing the segment (e.g. a digital address, not shown in FIG. 19). As discussed in greater detail below, each segment 1907 is defined by a duration 1911, a relative volume 1913 and a relative pitch 1915. Step 1703 may also generate a Universal Phonetic Alphabet 147-A (FIG. 3-A) or Universal Phonetic Library 149-A (FIG. 3-B, FIG. 18) for use in the process.

Columns 1917 and 1919 of Table 1900 are not that of the reference speaker reciting a selected text. Column 1917 contains a synthetic audio file of the selected text (e.g. the Gettysburg Address) derived from the Universal Phonetic Library 149-B of the Subject Voice Profile 143-B (FIG. 18, bottom right).

Although the text segments 1905 and audio files 1907 (FIG. 19) are depicted as syllables, embodiments are envisioned wherein only a single sound from the Universal Phonetic Alphabet is associated with a given row of Table 1900.

Referring briefly to FIG. 19, as noted, row 1913 depicts the relative volume of the sound or syllable related to a particular time stamp. The relative volume is necessarily measured against a “reference volume” (not shown). For example, a reference volume may be 60 dB. Therefore, a relative value 0 dB shown at time stamp TS.1 represents a volume of 60 dB. According to one embodiment, there is only a single reference volume against which all sounds are measured. According to an alternative embodiment, however, the Universal Phonetic Library 149-A (FIG. 18) of the reference voice contains reference volumes for each sound. For example, the “s” sound may not seem loud to the human ear, but because of the high frequency, may actually be louder than many vowel sounds that sound quite loud to the human ear. Therefore, a long “O” may be given a reference volume of 55 dB, and an “S” sound given a reference volume of 63 dB.

Row 1915 depicts the relative pitch of the sound or syllable related to a particular time stamp. The reader will readily appreciate that, although only a single “base” frequency is depicted, the appended claims fully envision a sufficient number of harmonics to represent a sound according to the voice 109-B of a subject speaker 108-B.

.For example, the base frequency of the typical adult male is from 85 to 180 Hz, and that of a typical adult female from 165 to 255 Hz. However, very few sounds are formed at this baseline. When forming a particular sound, the fundamental frequency is usually higher than the speakers base frequency, and the harmonics of various sounds are even higher. Additionally, the number of harmonics needed to meaningfully capture the voice of a subject speaker may also depend on the sound being produced. Perhaps a base harmonic is sufficient for an “s” sound, whereas, the reproduction of the “O” sound in the voice of a subject speaker, may require the base harmonic and four overtones. Embodiments of Table 19 are fully envisioned which include multiple rows for each sound, such that time Stamp TS.1 may include TS.1A, TS.1B, TS.1C . . . TS-1n to the extent necessary to capture the harmonics of the sound represented by time stamp TS.1. These specific details are fully envisioned within the appended claims, and the depiction of only a single frequency for each sound in Table 1900 is offered only for economy of description.

According to one embodiment, there is only a single set of reference harmonics for the Reference Voice Profile 143-A. For example, this may include the base frequency of 100 Hz, and four harmonics at predetermined frequencies 200 Hz, 400 Hz, 800 Hz and 1,600 Hz. According to such an embodiment, the relative pitch 1915 is referenced against this single base frequency and set of harmonics.

According to an alternative embodiment, however, the Universal Phonetic Library 149-A (FIG. 18) of the Reference Voice Profile 143-A includes different frequencies and overtones for every sound. For example, a first base frequency, and set of harmonics, may be associated with the phonetic sound “O,” whereas a different base frequency and set of harmonics may be associated with the “S” sound. According to such an embodiment, the relative pitch 1915 would be specifically referenced against the particular sound from the universal phonetic alphabet 147 (FIG. 3A).

It will be appreciated from the foregoing of multiple harmonics that each harmonic would have to be represented by its own relative volume in Table 1900.

Returning to FIG. 17, in step 1705, a subject 108-B (FIG. 18) reads text into the speech analysis module, which generates a personal voice profile 143-B (FIG. 18) of the subject, and stores the personal voice profile in a voice profile library. The subject voice profile may include a Universal Phonetic Alphabet 147-B, a Universal Phonetic Library 149-B, or both.

In step 1707, the user selects a text to be converted into a hybrid recording.

In step 1709, a user selects a the reference voice 109-B for the hybrid sound recording. For example, the user may want the rhythm and cadence of the hybrid sound recording to reflect that of a Shakespearean actor or an articulate screen actress.

In step 1711, the user selects a subject voce for the hybrid recording. The eventual recording will include the “tonality” of the subject voice, and will therefore sound as if it were spoken by the subject. For example, the wife of a submariner wants her children to hear bed time stories every night in their father's voice while he is on a four month patrol in a submarine. The father is the “subject voice.”

In specific application, by way of illustration, the user (the wife of the submariner) selects the story “The Emperor's New Clothes” by Hans Christian Anderson read through the reference voice of the late Sir Laurence Olivier, and further selects the subject voice of her husband.

In step 1713, the integration module 125 (FIG. 1) generates a preliminary subject audio file 1917 (FIG. 19) of the selected text The Emperor's New Clothes according to the tonality of the subject (the husband away on submarine patrol). As illustrated in conjunction with column 1917 of FIG. 19, this preliminary subject audio file includes a sequence of audio file segments corresponding to text segments 1907 of the Emperor's New Clothes, and further corresponding to the time stamps 1909 for each of these phonetic segments. This can be done, for instance, by identifying a sequence of audio files (UPL-1, UPL-134, UPL-92, etc., FIG. 3A) from the individual voice profile 143 (FIG. 1) of the subject.

In step 1715, the integration module 125 (FIG. 1) modulates each preliminary subject audio segment (the individual audio file stored in each row of column 1917) according to the cadence or duration 1911, relative volume 1913 and relative pitch 1915 associated with the same “row” or time stamp 1909 of a particular subject audio segment, forming a corresponding Hybrid Audio File Segment 1919. For example, referring to FIG. 19, row 3 (time stamp TS.3), the sound “k ā” is derived from the personal voice profile of the subject 143-B (FIG. 18), and stored in column in 1917. The sequence of Audio file segments 1919 together with their time stamps 1909 (FIG. 19) form a Hybrid Custom Synthetic Digital Voice Recording 138-H of FIGS. 1 and 18. The Hybrid Custom Synthetic Digital Voice Recording therefore utilizes the foundational frequency, and overtones of the subject (e.g. the father on submarine duty) for every sound, modified in pitch, volume and cadence according to the speech patterns of the reference voice, such as a skilled orator.

In step 1717, the user pays valuable consideration to buy or license the right to use the reference voice, or the right to buy or license the hybrid recording, or for the voice of the embodiments are envisioned wherein valuable consideration is offered to the reference person in exchange for the service of narrating the material. The reader will appreciate that any number of alternative transactions can be executed as well. For example, a one-time fee may be paid to the “reference person” for the service of narrating the text. Alternatively, or in addition to a one-time fee, royalties may also be paid to the reference person according to a predetermined schedule, such as annual royalties, or according to a number of times his voice is used to generate hybrid recordings. Fees may be paid to a network that performs the process of generating hybrid audio recordings. In view of creative internet marketing, such as methods developed by Google and Yahoo, there are a virtually unlimited number of ways in which commercial transactions can be performed which incorporate the methods and embodiments described above.

What is claimed is:

1. A method for generating a digital voice recording, comprising:
narrating, in a voice of a reference speaker, a preselected text, thereby extracting a first sequence of digital audio file segments;
storing, in a digital data table, the first sequence of digital audio file segments in correlation with a respective sequence of digital text segments corresponding to the preselected text;
storing, in a personal voice profile, a second plurality of digital audio file segments extracted, at least in part, from a voice of a subject speaker;
generating a preliminary audio file from a sequence of digital audio file segments selected from the second plurality of digital audio file segments, and arranged in an order to corresponding to the sequence of digital text segments; and,
modifying the preliminary audio file according to vocal attributes depicted in the first sequence of digital audio file segments to generate a hybrid digital audio file.

2. The method according to claim 1, wherein the first sequence of digital text segments comprises a sequence of phonetic text characters.

3. The method according to claim 1, wherein the vocal attributes depicted in the first sequence of digital audio file segments define a sequence of predetermined acoustic envelope shapes.

4. The method according to claim 1, wherein vocal attributes depicted in the first sequence of digital audio file segments includes a duration of a sound.

5. The method according to claim 1, wherein vocal attributes depicted in the first sequence of digital audio file segments includes a duration of a pause.

6. The method according to claim 1, wherein vocal attributes depicted in the first sequence of digital audio file segments includes a frequency differential.

7. The method according to claim 1, wherein vocal attributes depicted in the first sequence of digital audio file segments includes a volume differential.

8. The method according to claim 1, wherein the first sequence of digital audio file segments are distinguished by a first plurality of identifiers.

9. The method according to claim 8 wherein at least some of the plurality of identifiers comprise time stamps.

10. The method according to claim 9, wherein at least some of the plurality of identifiers comprise time stamps.

11. The method according to claim 9, wherein at least some of the plurality of identifiers comprise a data table address.

12. The method according to claim 2, wherein at least some of the sequence of phonetic text characters correspond to a specific word of the preselected text.

13. The method according to claim 2, wherein at least some of the sequence of phonetic text characters correspond to a specific digital audio file segment of the voice of the reference speaker.

14. The method according to claim 1, wherein at least some of the digital audio file segments extracted from the voice of the reference speaker include first and second frequencies superpositioned during a same segment of time.

15. The method according to claim 1, further comprising the step of paying a royalty for the right to use a voice selected from among a group of voices consisting of the reference voice, the subject voice, and combinations thereof.

16. A method for generating a digital voice recording, comprising:
storing, within a first data field, a first digital audio file segment extracted, at least in part, from a voice of a first speaker, wherein the first digital audio file segment corresponds to a first text segment from among a first text file, the first audio file segment having a first frequency, a first volume, and a first duration;
storing, within a second data field, a digital value representing the first duration;
storing, within a third data field, a second digital audio file segment extracted, at least in part, from a voice of a second speaker;
modulating the second digital audio file segment to form a third digital audio file segment having a duration equal to the first duration.

17. A method for generating a hybrid digital voice recording of a predetermined text narrative, the text narrative being comprised of a sequence of text segments corresponding to a sequence of discrete sounds of a spoken voice, the hybrid digital voice recording comprising attributes of a reference speaker and a subject speaker, the method comprising:
identifying a pitch modulation of a first overtone of a first discrete sound spoken by the reference speaker, a pitch modulation being a magnitude of a rise or fall in pitch of an overtone of a select discrete sound corresponding to a specific text segment when compared with a pitch of a reference sound;
identifying, within a voice profile library, a first discrete sound of the subject speaker corresponding to the first discrete sound of the reference speaker; and
modulating a first overtone of the first discrete sound of the subject speaker according to the pitch modulation of the first overtone of the first discrete sound spoken by the reference speaker, thereby forming a first hybrid tonal portion.

18. The method of claim 17 further comprising the steps:
identifying a pitch modulation of a second overtone of a first discrete sound spoken by the reference speaker; and,
modulating a second overtone of the first discrete sound of the subject speaker according to the modulation of the secondary overtone, thereby forming a second hybrid tonal portion.

19. The method of claim 18 further comprising the step of:
combining the first and second hybrid tonal portions to form a first discrete hybrid sound.

20. The method of claim 19 wherein the first discrete hybrid sound is stored on a digital storage medium.

21. The method of claim 20 further comprising the step of storing a second discrete hybrid sound on the digital storage medium.

22. The method of claim 21 further comprising the step of storing, on the digital storage medium, a first digital identifier corresponding to the first discrete hybrid sound, and a second digital identifier corresponding to the second discrete hybrid sound.

23. The method of claim 22 wherein the first and second digital identifiers are time stamps.

24. A method for generating a hybrid digital voice recording of a predetermined text narrative, comprising:
storing, within a first data field, a first digital audio file segment extracted, at least in part, from a voice of a first speaker, wherein the first digital audio file segment corresponds to a first text segment from among the predetermined text narrative, the first digital audio file segment having at least a primary overtone comprising a first frequency;
calculating a first frequency differential between the primary overtone of the first digital audio file segment and a first reference frequency;
storing, within a third data field, a second digital audio file segment extracted, at least in part, from a voice of a second speaker, the second digital audio file segment having at least a primary overtone comprising a first frequency;
modulating the first frequency of the primary overtone of the second digital audio file segment by a value derived from the frequency differential; and,
storing the modulated frequency in a fourth data field.

25. The method of claim 24 wherein the first reference frequency is derived from a first reference sound recorded from a voice of the reference speaker, and wherein the first reference sound corresponds to sound of a universal phonetic alphabet which corresponds to a sound represented by the first text segment.

26. A method for generating a hybrid digital voice recording of a predetermined text narrative, comprising:
storing, within a first data field, a first digital audio file segment extracted, at least in part, from a voice of a first speaker, wherein the first digital audio file segment corresponds to a first text segment from among the predetermined text narrative, the first digital audio file segment having a first volume;
storing, on a digital medium, a reference digital audio file segment;
measuring a first deviation in volume between a volume of the first volume and a volume of the reference digital audio file segment;
storing, on a digital medium, a second digital audio file segment derived from a voice of a subject speaker; and,
modulating a volume of the second digital audio file segment according to the first deviation in volume, thereby forming a hybrid digital audio file segment.

27. A method for generating a hybrid digital voice recording of a predetermined text narrative, having vocal attributes of first and second speakers, the method comprising:
generating a first voice recording in a voice of a first speaker, the first voice recording having vocal attributes from a first set of parameters, and vocal attributes from a second set of parameters;
generating a plurality of digital audio file segments in a voice of a second speaker, the digital audio file segments in the voice of the second speaker having vocal attributes from the first set of parameters; and,
generating a hybrid digital voice recording utilizing vocal attributes from among the second set of parameters of the first voice recording and vocal attributes of the first set of parameters from file segments of the voice of the second speaker.
